(19) United States
(12) Patent Application Publication
(10) Pub. No.: US 2024/0051683 A1
(43) Pub. Date: Feb. 15, 2024

(54) HYBRID CONSTELLATION, HYBRID CONSTELLATION FORMING METHOD, GROUND SYSTEM, MISSION SATELLITE, AND GROUND EQUIPMENT

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/267,453

(22) PCT Filed: Jul. 28, 2021
(86) PCT No.: PCT/JP2021/027825

§ 371 Date: Jun. 15, 2023

(30) Foreign Application Priority Data
Dec. 22, 2020 (JP) 2020-212305

(51) Int. Cl. B64G 1/10; H04W 24/04; G06T 3/40; G08G 5/00; G08G 5/04

(52) U.S. Cl. CPC B64G 1/1085; H04W 24/04; G06T 3/4053; G08G 5/0013; G08G 5/04; B64G 1/1007; H04W 84/18

(57) ABSTRACT

A first satellite includes a first communication device to communicate with satellites flying in front and behind in a same orbital plane, a second communication device to communicate with a satellite flying in an adjacent orbit, and a third communication device to communicate with ground equipment or a moving object. A second satellite includes a first communication device, a second communication device, a third communication device, and a monitoring device. A third satellite includes a first communication device, a third communication device, and a monitoring device. A fourth satellite includes a first communication device and a third communication device. In a satellite constellation, the first satellites, the second satellites, the third satellites, and the fourth satellites fly at a same altitude in the same orbital plane, and the satellites circularly flying in front and behind form a bidirectional communication cross-link so as to form an annular communication network.

### TECHNICAL FIELD

The present disclosure relates to satellite constellation, flying object handling system, information collection system, satellite information transmission system, satellite, hybrid constellation, hybrid constellation forming method, ground system, mission satellite, and ground equipment for monitoring systems.

### BACKGROUND ART

In recent years, with the emergence of flying objects that glide at supersonic speed, monitoring with satellites such as detection of flying object launches, flight path tracking, and prediction of landing position has been expected.

A promising means of detecting and tracking a flying object in a gliding phase is infrared detection of temperature rise which is caused by atmospheric friction generated when the flying object enters the atmosphere. Further, promising means of infrared detection of flying objects in a gliding phase is considered to be monitoring from a low earth orbit satellite group.

Patent Literature 1 discloses a monitoring satellite to comprehensively monitor a specific latitude region within the entire spherical surface of the earth with a small number of satellites orbiting in low earth orbit.

### CITATION LIST

### Patent Literature

Patent Literature 1: JP 4946398

### SUMMARY OF INVENTION

### Technical Problem

In monitoring from low earth orbit, a distance from an artificial satellite to a flying object is closer than that in monitoring from geostationary orbit. This makes it possible to improve detection performance by infrared rays. However, the monitoring from low earth orbit requires a large number of satellites to maintain constant monitoring. In the United States, realization of a system using a group of several hundred to over one thousand satellites is under consideration.

However, a large-scale system with a large number of satellites has a problem of a large cost scale.

An object of the present disclosure is to realize a satellite constellation for achieving a desired purpose in a monitoring system, with low cost.

### Solution to Problem

A satellite constellation according to the present invention is formed by:
a first satellite including
   a first communication device to communicate with satellites flying in front and behind in a same orbital plane,
   a second communication device to communicate with a satellite flying in an adjacent orbit, and
   a third communication device to communicate with ground equipment or a moving object on land, sea, or air;
a second satellite including
   a first communication device to communicate with satellites flying in front and behind in a same orbital plane,
   a second communication device to communicate with a satellite flying in an adjacent orbit,
   a third communication device to communicate with ground equipment or a moving object on land, sea, or air, and
   a monitoring device to monitor an object;
a third satellite including
   a first communication device to communicate with satellites flying in front and behind in a same orbital plane,
   a third communication device to communicate with ground equipment or a moving object on land, sea, or air, and
   a monitoring device to monitor an object; and
a fourth satellite including
   a first communication device to communicate with satellites flying in front and behind in a same orbital plane, and
   a third communication device to communicate with ground equipment or a moving object on land, sea, or air, wherein
a plurality of first satellites, a plurality of second satellites, a plurality of third satellites, and a plurality of fourth satellites fly at a same altitude in the same orbital plane, and satellites circularly flying in front and behind form a bidirectional communication link with a use of the first communication device so as to form an annular communication network.

### Advantageous Effects of Invention

In the satellite constellation according to the present disclosure, an annular communication network can be formed if six or more satellites form communication links with respective satellites in front and behind on the same orbital plane. Further, the first satellite to the fourth satellite are different from each other in their functions and costs in the satellite constellation according to the present disclosure. Therefore, configurations and combinations of satellites can be selected depending on a configuration purpose and budget of a satellite constellation. Accordingly, the satellite constellation according to the present disclosure provides an advantageous effect that makes it possible to realize a satellite constellation for achieving a desired purpose in a monitoring system, with low cost.

### BRIEF DESCRIPTION OF DRAWINGS

FIG. 1 illustrates an example of a satellite constellation having a plurality of orbital planes intersecting with each other at non-polar regions.

FIG. 2 illustrates a configuration example of a satellite constellation forming system according to Embodiment 1.

FIG. 3 illustrates an example of a configuration of a satellite in a satellite constellation according to Embodiment 1.

FIG. 4 illustrates another example of the configuration of the satellite in the satellite constellation according to Embodiment 1.

FIG. 5 illustrates a configuration example of ground equipment included in the satellite constellation forming system according to Embodiment 1.

FIG. 6 illustrates a functional configuration example of the satellite constellation forming system according to Embodiment 1.

FIG. 7 illustrates a configuration example of Example 1 of the satellite constellation according to Embodiment 1.

FIG. 8 illustrates an example in which satellites flying in front and behind on the same orbital plane according to Embodiment 1 communicate with each other by first communication devices.

FIG. 9 illustrates an example in which satellites flying in adjacent orbits according to Embodiment 1 communicate with each other by second communication devices.

FIG. 10 illustrates a configuration example of Example 2 of the satellite constellation according to Embodiment 1.

FIG. 11 illustrates a configuration example of Example 3 of the satellite constellation according to Embodiment 1.

FIG. 12 illustrates a configuration example of Example 4 of the satellite constellation according to Embodiment 1.

FIG. 13 illustrates an example of a mesh communication network of a satellite constellation according to Embodiment 2.

FIG. 14 illustrates an example of a flying object handling system according to Embodiment 3.

FIG. 15 illustrates an example of an information collection system according to Embodiment 3.

FIG. 16 illustrates an example of a satellite information transmission system according to Embodiment 3.

FIG. 17 illustrates an example of a hybrid constellation according to Embodiment 4.

FIG. 18 illustrates an example of a hybrid constellation according to Embodiment 5.

FIG. 19 is a diagram illustrating from Example 8 to Example 14 of a hybrid constellation according to Embodiment 7.

FIG. 20 is a diagram illustrating Example 15 of the hybrid constellation according to Embodiment 7.

FIG. 21 is a diagram illustrating Example 16 of ground equipment communicating with the hybrid constellation according to Embodiment 7.

FIG. 22 is a diagram illustrating an example of a synchronous control method according to Embodiment 6.

FIG. 23 is a diagram illustrating another example of the synchronous control method according to Embodiment 6.

### DESCRIPTION OF EMBODIMENTS

Embodiments of the present disclosure will be described below with reference to the accompanying drawings. Here, the same reference characters are given to the same or corresponding portions among the drawings. In the description of the embodiments, description will be omitted or simplified as appropriate for the same or corresponding portions. Further, in the following drawings, the relation between the sizes of components may differ from the actual relation. In addition, directions or positions such as “top”, “bottom”, “left”, “right”, “forward”, “rearward”, “front”, and “back” may be indicated, in the description of the embodiments. These notations are for convenience of description and do not limit the arrangement and orientation of structures such as devices, equipment, or components.

### Embodiment 1

An example of a satellite constellation 20 according to the following embodiment will be described.

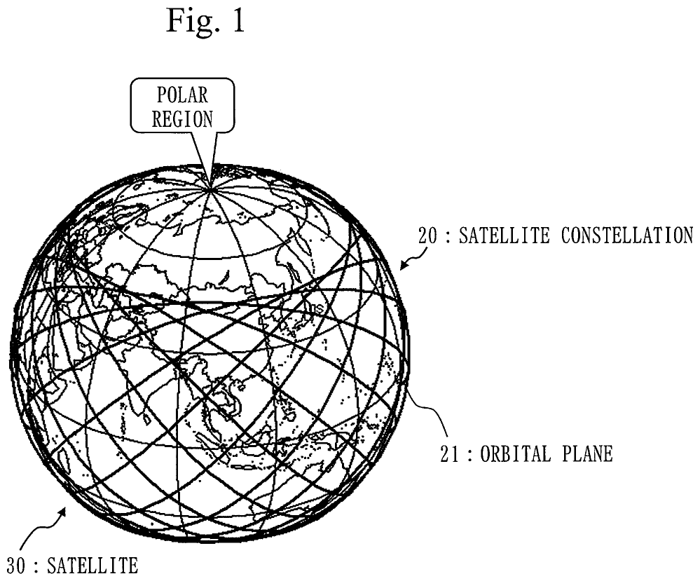

FIG. 1 illustrates an example of the satellite constellation 20 having a plurality of orbital planes 21 intersecting with each other at non-polar regions.

In the satellite constellation 20 of FIG. 1, a plurality of satellites 30 fly at the same altitude in the same orbital plane. The satellite 30 is also called an artificial satellite.

In the satellite constellation 20 of FIG. 1, orbital inclination angles of respective orbital planes 21 of a plurality of orbital planes are not approximately 90 degrees and the orbital planes 21 of the plurality of orbital planes are on mutually-different planes. Arbitrary two orbital planes intersect with each other at a non-polar point in the satellite constellation 20 of FIG. 1. As illustrated in FIG. 1, intersections of a plurality of orbital planes whose orbital inclination angles are larger than 90 degrees are farther from the polar regions depending on the orbital inclination angles. Further, the orbital planes may intersect at various positions including the vicinity of the equator, depending on a combination of orbital planes.

Other than the satellite constellation 20 of FIG. 1, there is a satellite constellation having the configuration in which orbital inclination angles of respective orbital planes of a plurality of orbital planes are approximately 90 degrees and the plurality of orbital planes intersect with each other in the vicinity of the polar regions.

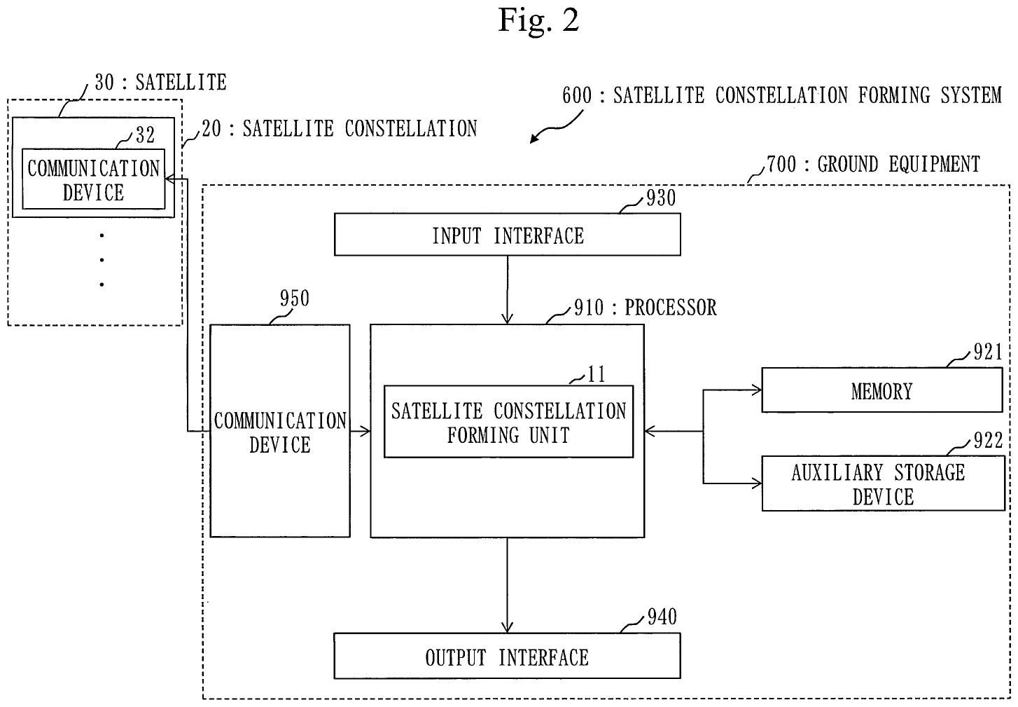

Examples of the satellite 30 and ground equipment 700 in a satellite constellation forming system 600 for forming the satellite constellation 20 will be described with reference to FIGS. 2 to 6. The satellite constellation forming system 600 is sometimes called merely a satellite constellation, a communication constellation, or a hybrid constellation.

FIG. 2 illustrates a configuration example of the satellite constellation forming system 600.

The satellite constellation forming system 600 includes a computer. Although FIG. 2 shows a configuration of a single computer, computers are provided to respective satellites 30 of a plurality of satellites constituting the satellite constellation 20 and respective pieces of ground equipment 700 that communicate with the satellites 30 in practice. The computers provided to respective satellites 30 of a plurality of satellites and respective pieces of ground equipment 700 communicating with the satellites 30 work together to realize a function of the satellite constellation forming system 600. An example of the configuration of the computer realizing the function of the satellite constellation forming system 600 will be described below.

The satellite constellation forming system 600 includes the satellite 30 and the ground equipment 700. The satellite 30 includes a communication device 32 that communicates with a communication device 950 of the ground equipment 700. FIG. 2 illustrates the communication device 32 among components included in the satellite 30.

The satellite constellation forming system 600 includes a processor 910 and other hardware such as a memory 921, an auxiliary storage device 922, an input interface 930, an output interface 940, and the communication device 950. The processor 910 is connected with other hardware via a signal line and controls these pieces of hardware.

The satellite constellation forming system 600 includes a satellite constellation forming unit 11 as a functional element. A function of the satellite constellation forming unit 11 is realized by software or hardware.

The satellite constellation forming unit 11 controls formation of the satellite constellation 20 while communicating with the satellite 30.

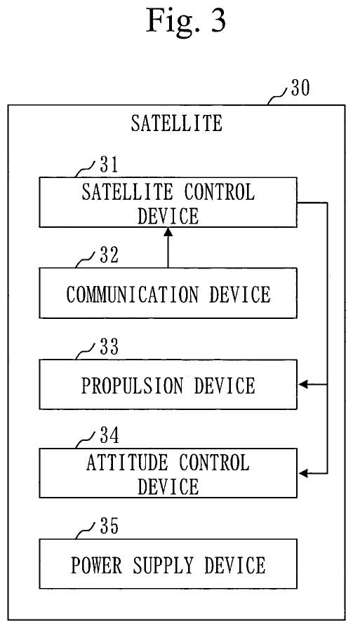

FIG. 3 illustrates an example of the configuration of the satellite 30 in the satellite constellation forming system 600.

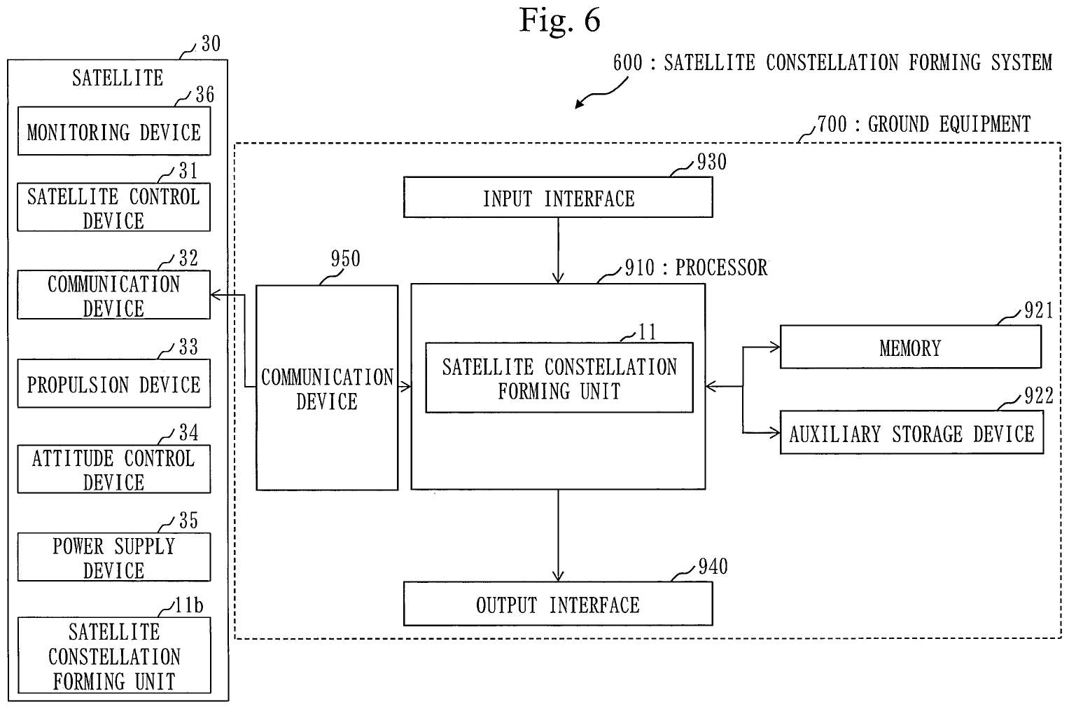

The satellite 30 includes a satellite control device 31, a communication device 32, a propulsion device 33, an attitude control device 34, and a power supply device 35. Other components for realizing various functions may also be included, but the satellite control device 31, the communication device 32, the propulsion device 33, the attitude control device 34, and the power supply device 35 will be described in FIG. 6.

The satellite control device 31 is a computer that controls the propulsion device 33 and the attitude control device 34, and includes a processing circuit. Specifically, the satellite control device 31 controls the propulsion device 33 and the attitude control device 34 in accordance with various commands transmitted from the ground equipment 700.

The communication device 32 is a device that communicates with the ground equipment 700. Alternatively, the communication device 32 is a device that communicates with satellites 30 in front and behind in the same orbital plane or communicates with satellites 30 in adjacent orbital planes. Specifically, the communication device 32 transmits various types of data related to own satellite to the ground equipment 700 or other satellites 30. Further, the communication device 32 receives various commands transmitted from the ground equipment 700.

The propulsion device 33 is a device to provide propulsion to the satellite 30 and changes the speed of the satellite 30.

The attitude control device 34 is a device to control attitude elements such as the attitude of the satellite 30 and the angular velocity and line of sight direction of the satellite 30. The attitude control device 34 changes each attitude element in a desired direction. Alternatively, the attitude control device 34 keeps each attitude element in a desired direction. The attitude control device 34 includes an attitude sensor, an actuator, and a controller. The attitude sensor is a device such as a gyroscope, an earth sensor, a sun sensor, a star tracker, a thruster, and a magnetic sensor. The actuator is a device such as an attitude control thruster, a momentum wheel, a reaction wheel, and a control moment gyro. The controller controls the actuator in accordance with measurement data of the attitude sensor or various commands from the ground equipment 700.

The power supply device 35 includes equipment such as a solar cell, a battery, and a power control device, and supplies power to each equipment mounted on the satellite 30.

The processing circuit included in the satellite control device 31 will be described.

The processing circuit may be dedicated hardware or a processor that executes a program stored in a memory.

In the processing circuit, a part of the function may be realized by dedicated hardware and the rest of the function may be realized by software or firmware. That is, the processing circuit can be realized by hardware, software, firmware, or a combination of these.

The dedicated hardware is specifically a single circuit, a composite circuit, a programmed processor, a parallel programmed processor, an ASIC, an FPGA, or a combination of these.

ASIC is an abbreviated name of Application Specific Integrated Circuit. FPGA is an abbreviated name of Field Programmable Gate Array.

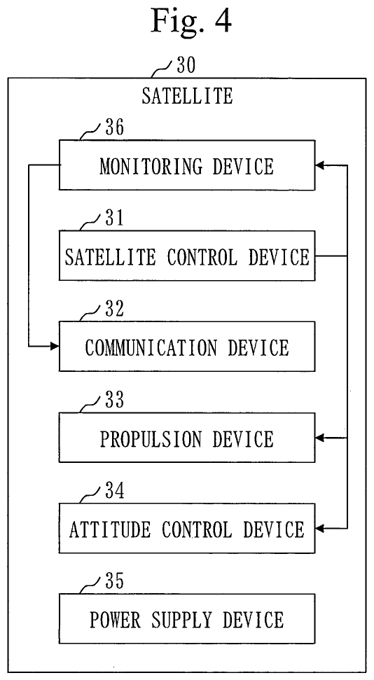

FIG. 4 illustrates another example of the configuration of the satellite 30 in the satellite constellation forming system 600.

The satellite 30 of FIG. 4 includes a monitoring device 36 in addition to the components of FIG. 3.

The monitoring device 36 is a device that monitors an object. Specifically, the monitoring device 36 is a device for monitoring or observing objects such as space objects, flying objects, and moving objects on land, sea, or air. The monitoring device 36 is also called an observation device.

For example, the monitoring device 36 is an infrared monitoring device that detects temperature rise caused by atmospheric friction generated when a flying object enters the atmosphere with infrared rays. The monitoring device 36 detects a temperature of a plume or body of a flying object in launch of the flying object.

Alternatively, the monitoring device 36 may be a light wave or radio wave information collection device. The monitoring device 36 may be a device that detects an object with an optical system. The monitoring device 36 takes an image of an object flying at an altitude, which is different from an orbital altitude of an observation satellite, with an optical system. Specifically, the monitoring device 36 may be a visible optical sensor.

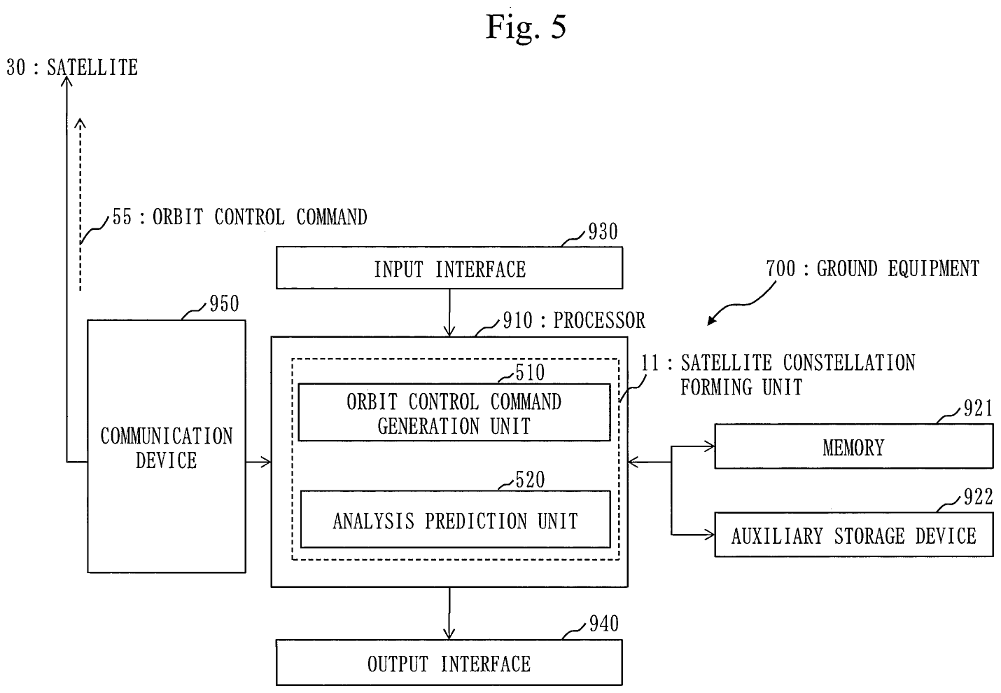

FIG. 5 illustrates a configuration example of the ground equipment 700 included in the satellite constellation forming system 600.

The ground equipment 700 performs program control of multiple satellites in all orbital planes. The ground equipment 700 is also called a ground device or a ground system. The ground device is composed of a ground station such as a ground antenna device, a communication device connected to the ground antenna device, and an electronic calculator, and ground equipment serving as a server or a terminal connected to the ground station with a network. Further, the ground device may include a communication device mounted on moving objects such as an aircraft, a self-driving vehicle, and a mobile terminal.

The ground system operates and controls the satellite constellation, the flying object handling system, the information collection system, the satellite information transmission system, or the hybrid constellation that are described in embodiments of the present disclosure.

The ground equipment 700 forms the satellite constellation 20 by communicating with the satellites 30. The ground equipment 700 includes a processor 910 and other hardware such as a memory 921, an auxiliary storage device 922, an input interface 930, an output interface 940, and the communication device 950. The processor 910 is connected with other hardware via a signal line and controls these pieces of hardware.

The ground equipment 700 includes an orbit control command generation unit 510 and an analysis prediction unit 520 as functional elements. Functions of the orbit control command generation unit 510 and analysis prediction unit 520 are realized by hardware or software.

The communication device 950 transmits and receives signals for tracking and controlling the respective satellites 30 of the satellite group constituting the satellite constellation 20. Further, the communication device 950 transmits an orbit control command 55 to each satellite 30.

The analysis prediction unit 520 analyzes and predicts an orbit of the satellite 30.

The orbit control command generation unit 510 generates the orbit control command 55 which is to be transmitted to the satellite 30.

The orbit control command generation unit 510 and the analysis prediction unit 520 realize the function of the satellite constellation forming unit 11. That is, the orbit control command generation unit 510 and the analysis prediction unit 520 are examples of the satellite constellation forming unit 11.

FIG. 6 is a diagram illustrating a functional configuration example of the satellite constellation forming system 600.

The satellite 30 further includes a satellite constellation forming unit 11b for forming the satellite constellation 20. The satellite constellation forming units 11b of respective satellites 30 of a plurality of satellites and the satellite constellation forming units 11 provided to the respective pieces of ground equipment 700 work together to realize the function of the satellite constellation forming system 600. Here, the satellite constellation forming unit 11b of the satellite 30 may be provided to the satellite control device 31.

***Description for Configuration and Advantageous Effects of Satellite Constellation***

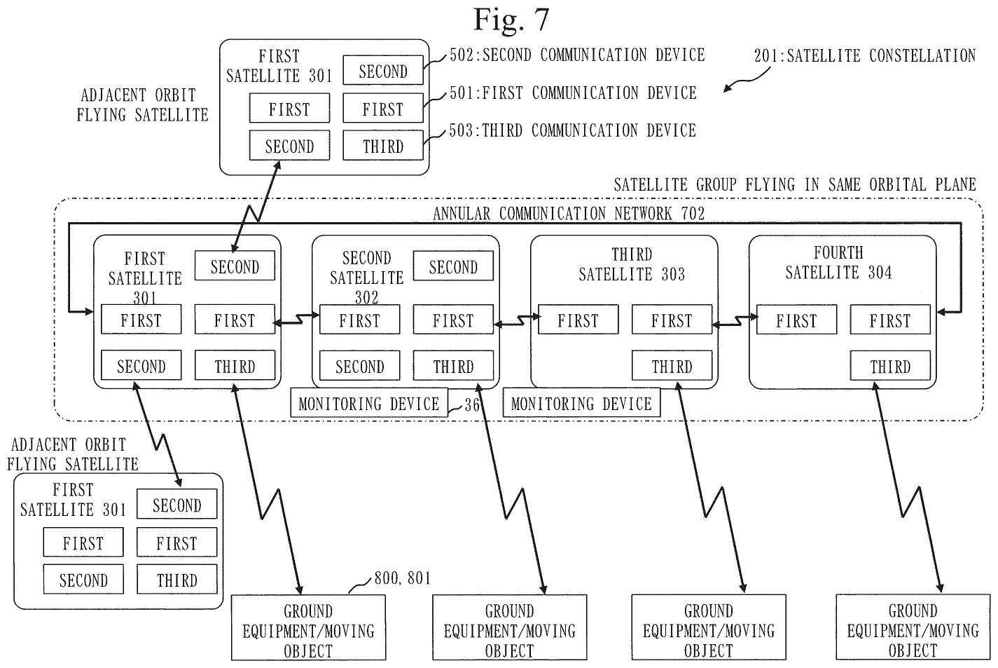

An example of the satellite constellation 20 according to the present embodiment will now be described with reference to FIGS. 7 to 12.

The following description will provide the same reference characters to communication devices or monitoring devices that are included in respective satellites 30 of a first satellite 301 to a fifth satellite 305. However, the same reference characters are provided so as to simplify the description of functions and the satellites are provided with individual separate devices in practice.

The first satellite 301, the second satellite 302, the third satellite 303, the fourth satellite 304, and the fifth satellite 305, which will be described below, are examples of the satellite 30.

### Example 1 of Satellite Constellation 20: Satellite Constellation 201

FIG. 7 is a diagram illustrating a configuration example of the satellite constellation 201 according to the present embodiment.

The satellite constellation 201 is Example 1 of the satellite constellation 20 according to the present embodiment. The satellite constellation 201 is composed, for example, of the satellite constellation forming system 600.

The satellite constellation 201 is composed of the first satellite 301, the second satellite 302, the third satellite 303, and the fourth satellite 304.

The first satellite 301 includes a first communication device 501, a second communication device 502, and a third communication device 503.

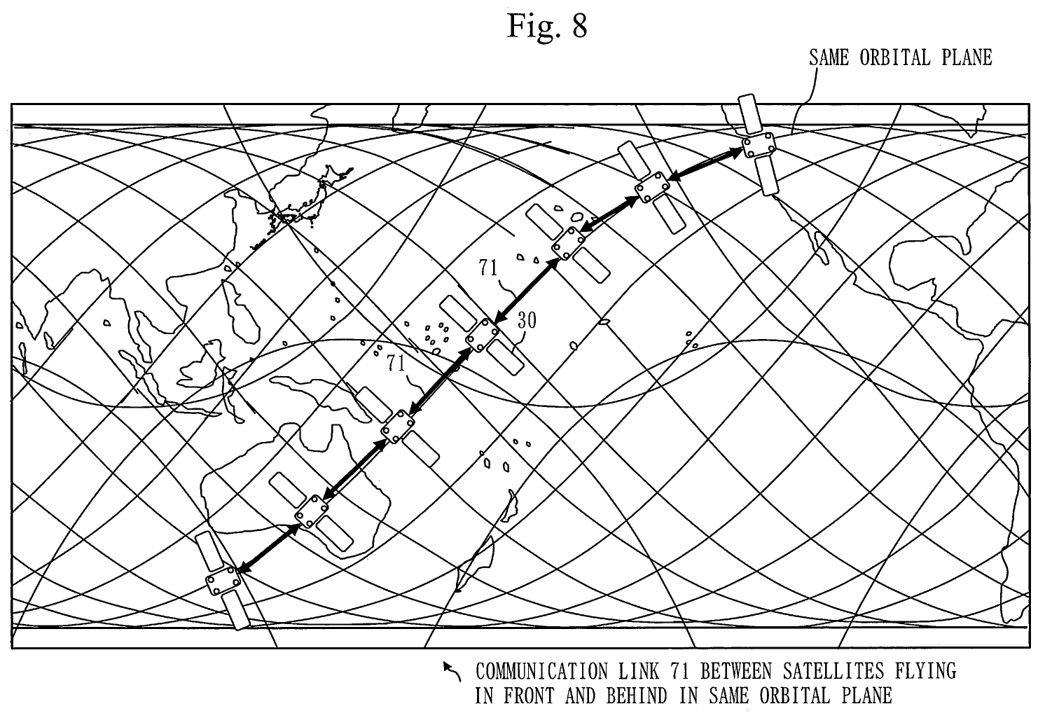

FIG. 8 is a diagram illustrating an example in which satellites flying in front and behind on the same orbital plane according to the present embodiment communicate with each other by the first communication devices 501.

As illustrated in FIGS. 7 and 8, the first communication device 501 communicates with satellites flying in front and behind in the same orbital plane. Specifically, the first communication device 501 of the satellite 30 forms bidirectional communication links 71 with the first communication devices 501 included in respective satellites flying in front and behind in the same orbital plane. Forming the communication link 71 enables bidirectional communication between satellites flying in front and behind in the same orbital plane.

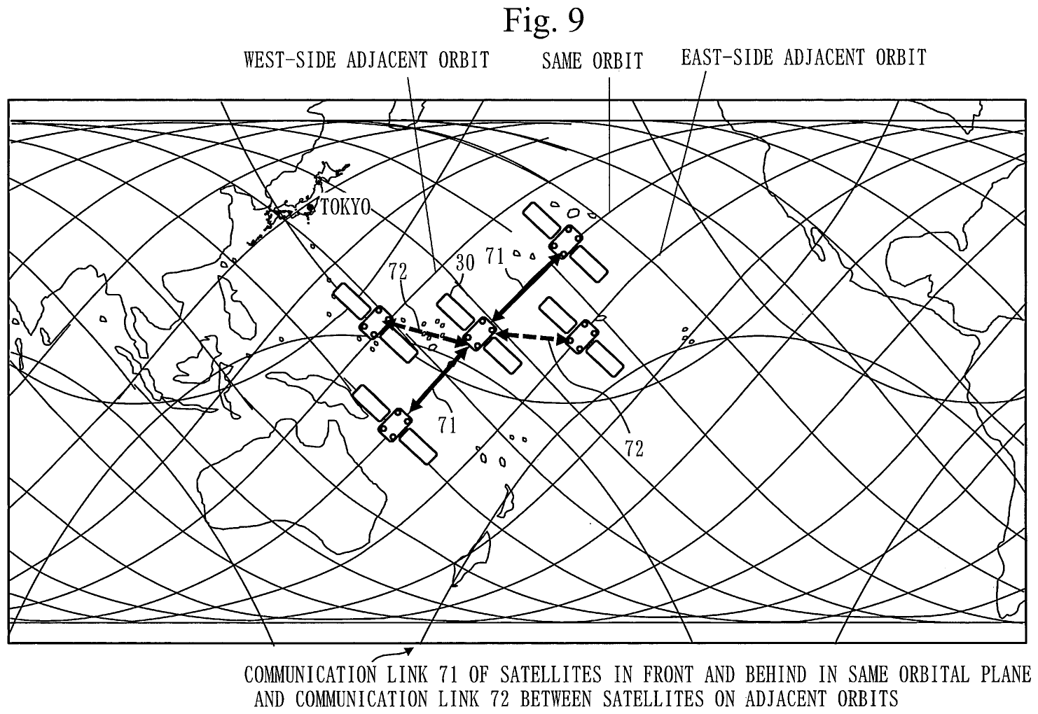

FIG. 9 is a diagram illustrating an example in which satellites flying in adjacent orbits according to the present embodiment communicate with each other by the second communication devices 502.

As illustrated in FIGS. 7 and 9, the second communication device 502 communicates with satellites flying in adjacent orbits. Specifically, the second communication device 502 of the satellite 30 forms bidirectional communication links 72 with the second communication devices 502 included in respective satellites flying in adjacent orbits. In FIG. 9, the second communication device 502 of the satellite 30 forms bidirectional communication links 72 with second communication devices 502 included in respective satellites flying in an east-side adjacent orbit and a west-side adjacent orbit. Forming the communication link 72 enables bidirectional communication with satellites flying in adjacent orbits.

The third communication device 503 communicates with ground equipment 800 or moving objects 801 on land, sea, or air. The ground equipment 800 includes the ground equipment 700 of the satellite constellation forming system 600. Further, the ground equipment 800 includes ground equipment, a ground device, or a ground facility, which is provided with a communication device exchanging various types of information with the satellite 30. Furthermore, the moving objects 801 on land, sea, or air include various moving objects used on the earth. Specifically, moving objects such as vehicles, ships, submarines, and flying objects, which are provided with a communication device exchanging various types of information with the satellite 30, are included.

The second satellite 302 includes the first communication device 501, the second communication device 502, the third communication device 503, and the monitoring device 36.

Functions of the first communication device 501, the second communication device 502, and the third communication device 503 are the same as the function of the first satellite 301, as mentioned above.

The monitoring device 36 is a device for monitoring objects such as space objects, flying objects, and moving objects on land, sea, or air, as mentioned above.

The third satellite 303 includes the first communication device 501, the third communication device 503, and the monitoring device 36.

Functions of the first communication device 501, the third communication device 503, and the monitoring device 36 are the same as the function of the first satellite 301 or the second satellite 302, as mentioned above.

The fourth satellite 304 includes the first communication device 501 and the third communication device 503.

Functions of the first communication device 501 and the third communication device 503 are the same as the function of the first satellite 301, as mentioned above.

In the satellite constellation 201, a plurality of first satellites 301, a plurality of second satellites 302, a plurality of third satellites 303, and a plurality of fourth satellites 304 fly at the same altitude in the same orbital plane. Satellites 30 circularly flying in front and behind form bidirectional communication links with the use of the first communication devices 501, thus forming an annular communication network 702 which is a communication network having an annular shape. The bidirectional communication link is also called a communication cross-link.

In the satellite constellation 201, an annular communication network can be formed if six or more satellites form communication cross-links with respective satellites in front and behind on the same orbital plane. The first satellite 301 to the fourth satellite 304 are different from each other in their functions and costs. This provides an advantageous effect that makes it possible to select configurations and combinations of satellites depending on a configuration purpose and budget of the corresponding satellite constellation. Thus, the satellite constellation 201 provides an advantageous effect that makes it possible to realize a satellite constellation for achieving a desired purpose in a monitoring system, with low cost.

Further, in the satellite constellation 201, the satellites 30 fly in formation of a bead line at the same altitude in the same orbital plane. The satellite constellation 201 provides an advantageous effect that if an annular communication network is formed by making communication cross-links with satellites in front and behind by the first communication devices 501, it is possible to communicate with adjacent orbits via the first satellite 301 or the second satellite 302 provided with the second communication device 502 on the same orbital plane.

Further, there is an advantageous effect that an arbitrary satellite provided with the third communication device 503 can communicate with the ground or moving objects on land, sea, or air, in the satellite constellation 201.

### Example 2 of Satellite Constellation 20: Satellite Constellation 202

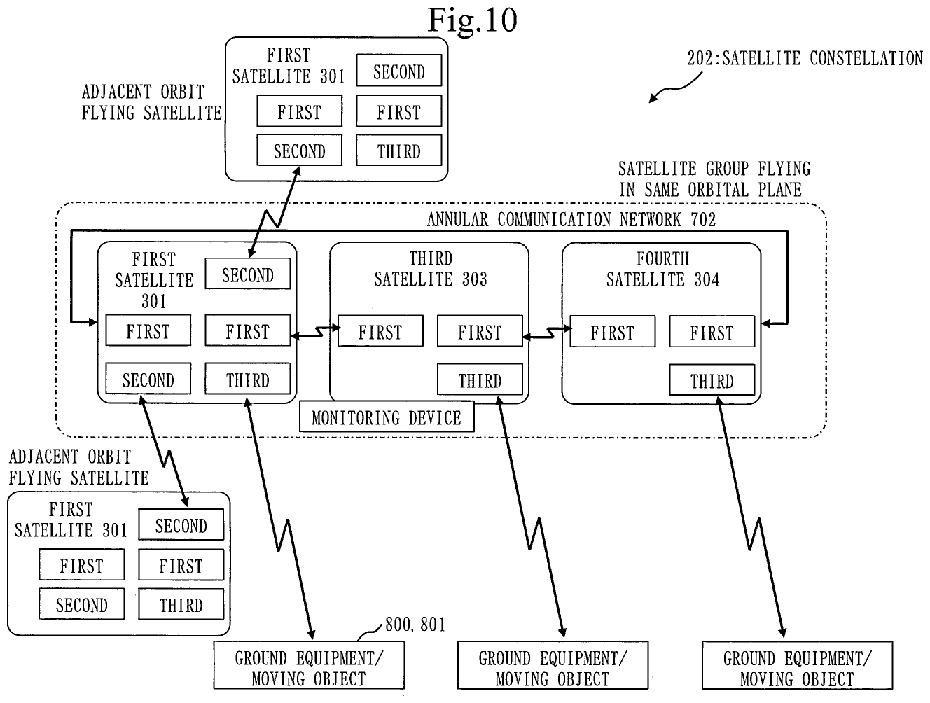

FIG. 10 is a diagram illustrating a configuration example of the satellite constellation 202 according to the present embodiment.

The satellite constellation 202 is Example 2 of the satellite constellation 20 according to the present embodiment. The satellite constellation 202 is composed, for example, of the satellite constellation forming system 600.

The satellite constellation 202 is composed of the first satellite 301, the third satellite 303, and the fourth satellite 304.

The first satellite 301 includes the first communication device 501, the second communication device 502, and the third communication device 503.

The third satellite 303 includes the first communication device 501, the monitoring device 36, and the third communication device 503.

The fourth satellite 304 includes the first communication device 501 and the third communication device 503.

In the satellite constellation 202, a plurality of first satellites 301, a plurality of third satellites 303, and a plurality of fourth satellites 304 fly at the same altitude in the same orbital plane. Satellites 30 circularly flying in front and behind form bidirectional communication links with the use of the first communication devices 501, thus forming an annular communication network 702. That is, satellites 30 circularly flying in front and behind form communication cross-links by the first communication devices 501, thus forming the annular communication network 702.

The second satellite 302 described in Example 1 of the satellite constellation 20 has a problem in that a layout, implementation, and an operation in the communication device and the monitoring device are complicated, resulting in high cost.

The satellite constellation 202 provides an advantageous effect that a desired purpose can be realized at low cost by transmitting information of the monitoring device 36 via front and rear satellites without including expensive second satellites 302. Especially, when information of the monitoring device 36 is transmitted to satellites on adjacent orbits, the transmission can be performed via satellites in front and behind in the satellite constellation 202.

### Example 3 of Satellite Constellation 20: Satellite Constellation 203

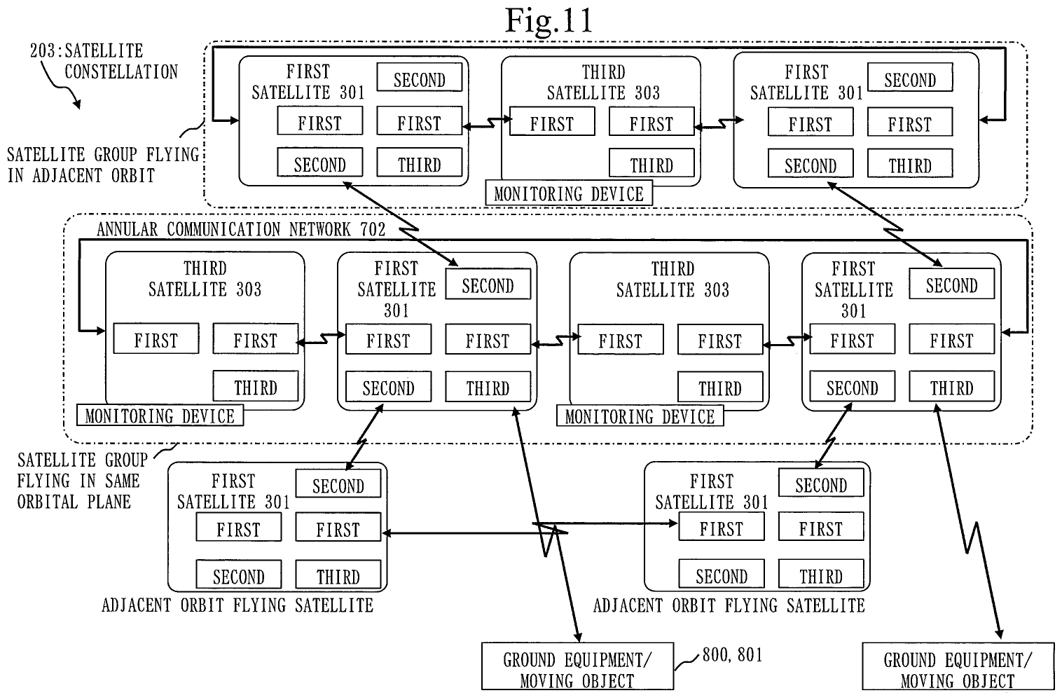

FIG. 11 is a diagram illustrating a configuration example of the satellite constellation 203 according to the present embodiment.

The satellite constellation 203 is Example 3 of the satellite constellation 20 according to the present embodiment. The satellite constellation 203 is composed, for example, of the satellite constellation forming system 600.

The satellite constellation 203 is composed of the first satellite 301 and the third satellite 303.

The first satellite 301 includes the first communication device 501, the second communication device 502, and the third communication device 503.

The third satellite 303 includes the first communication device 501, the monitoring device 36, and the third communication device 503.

In the satellite constellation 203, a plurality of first satellites 301 and a plurality of third satellites 303 fly at the same altitude in the same orbital plane. Satellites 30 circularly flying in front and behind form a bidirectional communication link with the use of the first communication devices 501, thus forming the annular communication network 702. That is, satellites 30 circularly flying in front and behind form a communication cross-link by the first communication devices 501, thus forming the annular communication network 702.

Multiple first satellites are deployed in the same orbital plane and multiple orbital planes are arranged to be distributed in a longitude direction, being able to form a mesh communication network by communication cross-links within the same orbital plane formed by first communication devices and communication cross-links between adjacent orbital planes formed by second communication devices. By employing the satellite constellation 203, a third satellite can be allowed to interrupt in this mesh communication network so as to be a component of the annular communication network 702 in the same orbital plane. Thus, the employment of the satellite constellation 203 provides an advantageous effect that enables monitoring and transmission of monitoring information by the third satellite while maintaining the original communication service of the mesh communication network.

### Example 4 of Satellite Constellation 20: Satellite Constellation 204

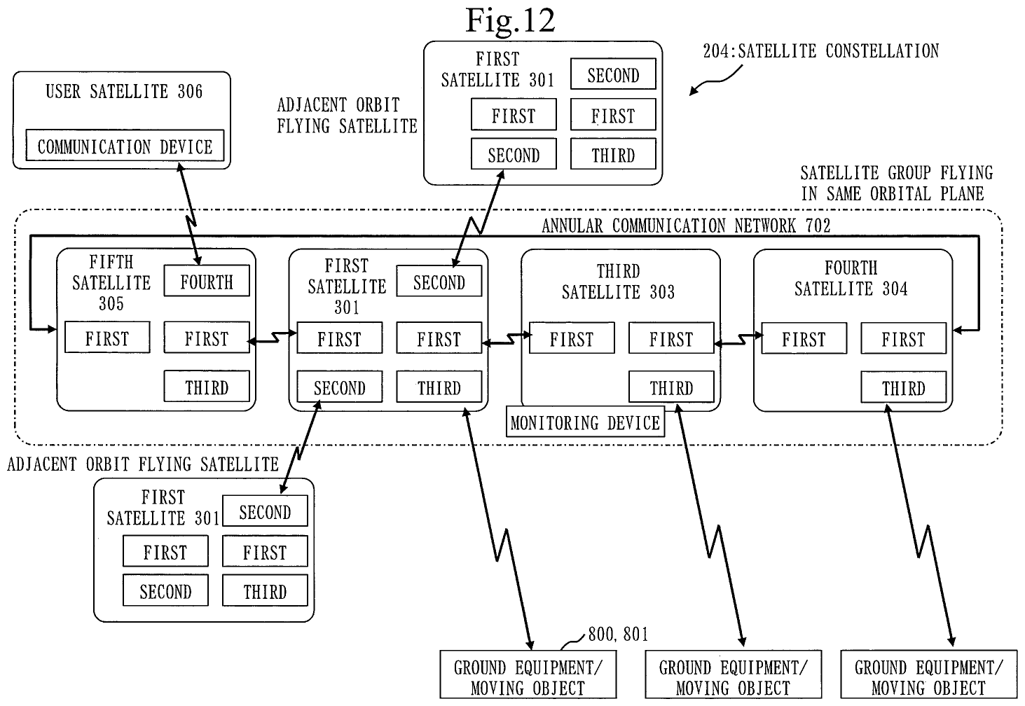

FIG. 12 is a diagram illustrating a configuration example of the satellite constellation 204 according to the present embodiment.

The satellite constellation 204 is Example 4 of the satellite constellation 20 according to the present embodiment. The satellite constellation 204 is composed, for example, of the satellite constellation forming system 600.

The satellite constellation 204 is composed of the first satellite 301, the fifth satellite 305, the third satellite 303, and the fourth satellite 304.

The first satellite 301 includes the first communication device 501, the second communication device 502, and the third communication device 503.

The third satellite 303 includes the first communication device 501, the third communication device 503, and the monitoring device 36.

The fourth satellite 304 includes the first communication device 501 and the third communication device 503.

The fifth satellite 305 includes the first communication device 501, the third communication device 503, and a fourth communication device 504.

The fourth communication device 504 communicates with a user satellite 306 such as an observation satellite, a positioning satellite, and a communication satellite.

The satellite constellation 204 includes one or a plurality of fifth satellites 305 and at least the first satellite 301 in the same orbital plane. The satellite constellation 204 may further include the third satellite 303 and the fourth satellite 304. Satellites in the satellite constellation 204 fly at the same altitude. Satellites 30 circularly flying in front and behind form bidirectional communication links with the use of the first communication devices 501, thus forming the annular communication network 702. That is, satellites circularly flying in front and behind form a communication cross-link by the first communication devices 501, thus forming the annular communication network 702.

The user satellite 306 such as an observation satellite, a positioning satellite, and a communication satellite are required to exchange information via a communication network formed at a low orbital altitude. Therefore, the satellite constellation 204 includes the fifth satellite 305 that is provided with the fourth communication device 504, which communicates with the user satellite 306, in the annular communication network 702 in the same orbital plane. This provides an advantageous effect to make it possible to form a mesh communication network having a function of relaying data by inter-satellite communication.

Even when the satellite constellation 204 does not include the third satellite 303 or the fourth satellite 304, a similar advantageous effect can be obtained.

Here, description will be provided on hardware included in a computer of each device such as the satellite constellation forming system 600, the ground equipment 700, the ground equipment 800, and the satellite 30 that constitute the satellite constellation 20.

The processor 910 is a device that executes a program for realizing a function of each device.

The processor 910 is an IC (Integrated Circuit) for performing arithmetic processing. Specific examples of the processor 910 include a CPU (Central Processing Unit), a DSP (Digital Signal Processor), and a GPU (Graphics Processing Unit).

The memory 921 is a storage device for temporarily storing data. Specific examples of the memory 921 include an SRAM (Static Random Access Memory) and a DRAM (Dynamic Random Access Memory).

The auxiliary storage device 922 is a storage device for storing data. Specific examples of the auxiliary storage device 922 include an HDD. Further, the auxiliary storage device 922 may be a portable storage medium such as an SD (registered trademark) memory card, a CF, a NAND flash, a flexible disk, an optical disk, a compact disk, a Blu-ray (registered trademark) disk, and a DVD. Here, HDD is an abbreviated word of Hard Disk Drive. SD (registered trademark) is an abbreviated word of Secure Digital. CF is an abbreviated word of CompactFlash (registered trademark). DVD is an abbreviated word of Digital Versatile Disk.

The input interface 930 is a port that is connected with an input device such as a mouse, a keyboard, and a touch panel. The input interface 930 is specifically a USB (Universal Serial Bus) terminal. Here, the input interface 930 may be a port that is connected with a LAN (Local Area Network).

The output interface 940 is a port to which a cable of a display device 941 such as a display is connected. The output interface 940 is specifically a USB terminal or an HDMI (registered trademark) (High Definition Multimedia Interface) terminal. The display is specifically an LCD (Liquid Crystal Display).

The communication device 950 includes a receiver and a transmitter. The communication device 950 is specifically a communication chip or a NIC (Network Interface Card).

The program for realizing a function of each device is read in the processor 910 and executed by the processor 910. The memory 921 stores an OS (Operating System) as well as the program. The processor 910 executes the program while executing the OS. The program and the OS may be stored in the auxiliary storage device 922. The program and the OS stored in the auxiliary storage device 922 are loaded on the memory 921 and executed by the processor 910. Here, part or the whole of the program for realizing a function of each device may be incorporated in the OS. Each device may include a plurality of processors substituting for the processor 910. These plurality of processors share the execution of the program. Each of the processors is a device that executes the program as the processor 910.

Data, information, a signal value, and a variable value that are used, processed, or outputted based on the program are stored in the memory 921, the auxiliary storage device 922, or a register or cache memory in the processor 910.

The “unit” of each unit of each device may be read as “process”, “procedure”, “means”, “stage”, “circuitry”, or “step”. Further, the “unit” of each unit of each device may be read as “program”, “program product”, or “computer-readable recording medium on which a program is recorded”. The “process”, “procedure”, “means”, “stage”, “circuitry”, or “step” can be read interchangeably.

### Embodiment 2

In the present embodiment, points different from Embodiment 1 and points to be added to Embodiment 1 will be mainly described.

The present embodiment will provide the same reference characters to components having the same functions as those in Embodiment 1 and will omit the description thereof.

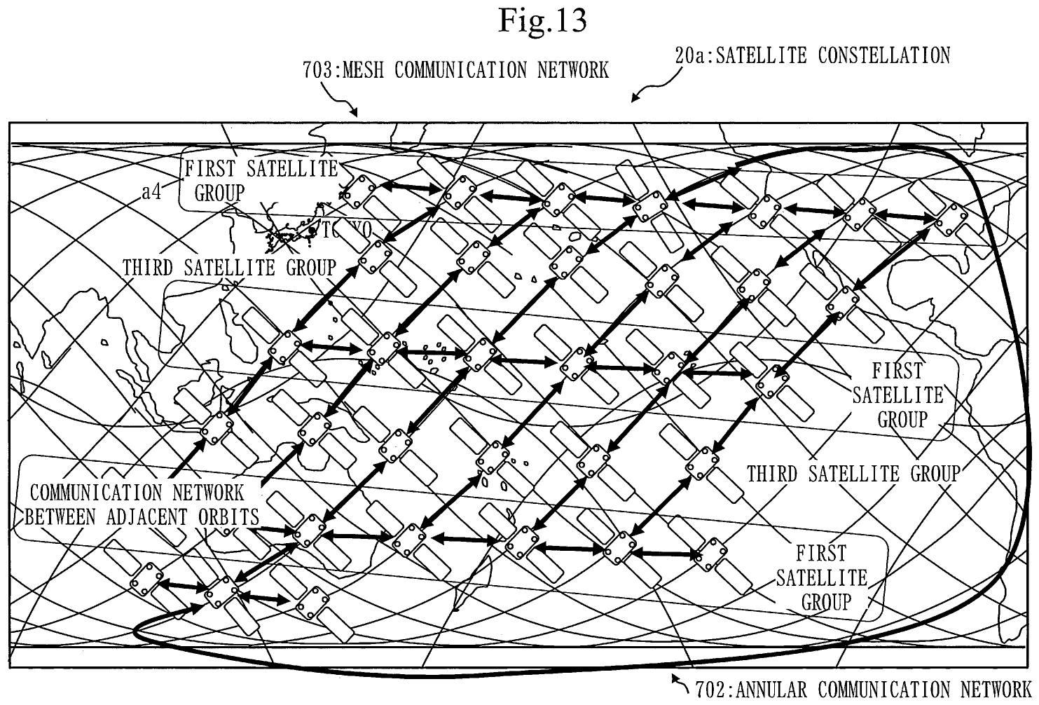

FIG. 13 is a diagram illustrating a satellite constellation 20a according to the present embodiment.

In the satellite constellation 20a according to the present embodiment, arbitrary satellite constellations having six or more orbital planes from the satellite constellations 201, 202, 203, and 204, which are described in Embodiment 1, are arranged to be distributed in the longitude direction. Further, satellites between adjacent orbits form communication cross-links by the second communication devices 502, thus forming a mesh communication network 703, which is a mesh-like communication network.

As illustrated in FIG. 13, satellites provided with the second communication device 502 form a communication network between adjacent orbits. An example of this is the first satellite group. Further, satellites provided with no second communication device 502 only perform front and rear communication in the same orbital plane without forming a communication network between adjacent orbits. An example of this is the third satellite group.

The satellite constellations 201, 202, 203, and 204 having the annular communication network 702 are arranged to be distributed in the longitude direction and communication cross-links between adjacent orbits are made by the second communication devices 502, thus forming an annular communication network that circles the earth in the longitude direction. Accordingly, the mesh communication network 703 can be formed, providing an advantageous effect that monitoring information can be immediately transmitted to an arbitrary destination in the whole sphere.

If all orbital planes are formed at the same orbital altitude, a relative relationship of the orbital planes is maintained, providing an advantageous effect that monitoring and communication services can be stably continued.

However, when all orbital planes are formed at the same orbital altitude, there is a risk that the orbital planes collide on the orbit. Therefore, changing an orbital altitude for every orbital plane provides an advantageous effect to drastically reduce collision establishment. Here, there is a problem in that relative relationships between orbital planes changes over time. As a countermeasure, orbital plane altitudes are varied so that identical average orbital altitudes are obtained. Average relative relationship of the orbital planes is thus maintained, providing an advantageous effect that the collision risk can be drastically reduced.

### Embodiment 3

In the present embodiment, the points to be added to Embodiments 1 and 2 will be mainly described.

The present embodiment will provide the same reference characters to components having the same functions as those in Embodiments 1 and 2 and will omit the description thereof.

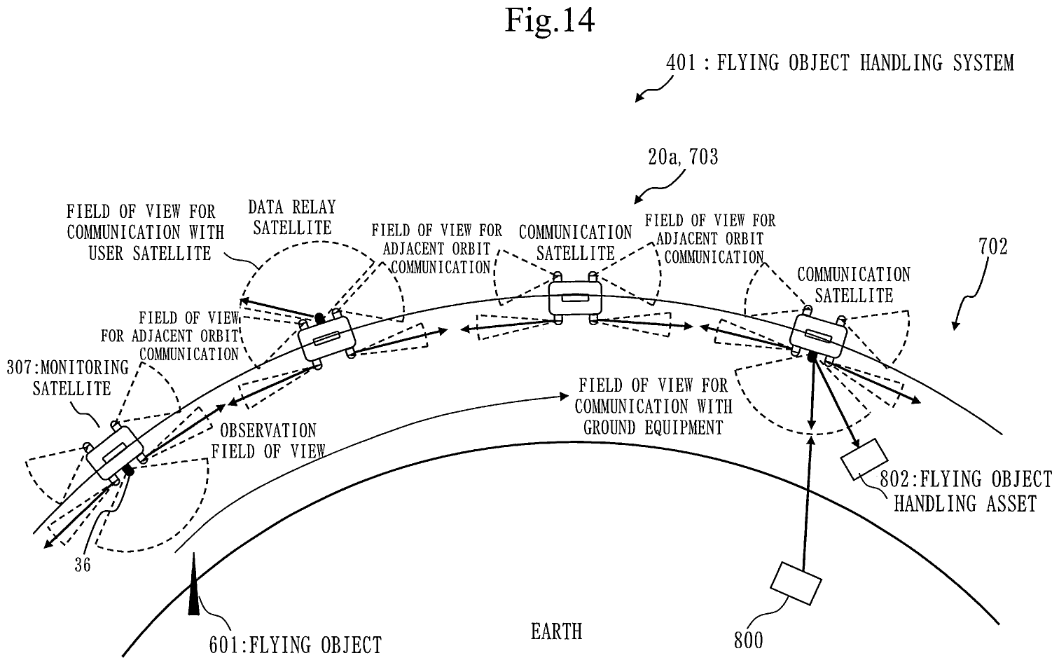

FIG. 14 is a diagram illustrating a flying object handling system 401 according to the present embodiment.

A monitoring satellite 307 that is an example of the satellite 30 includes the monitoring device 36. The monitoring device 36 is an infrared monitoring device. The monitoring device 36 detects a temperature of a plume or body of a flying object 601 in launch of the flying object 601 and acquires flying object information.

The flying object handling system 401 transmits the flying object information to the ground equipment 800 or flying object handling assets 802 on land, sea, and air via the mesh communication network 703 formed by the satellite constellation 20a described in Embodiment 2.

According to the flying object handling system 401, there is an advantageous effect that it is possible to perform launch detection and tacking of hypersonic glide vehicles (HGVs) which intermittently repeat injection after launch.

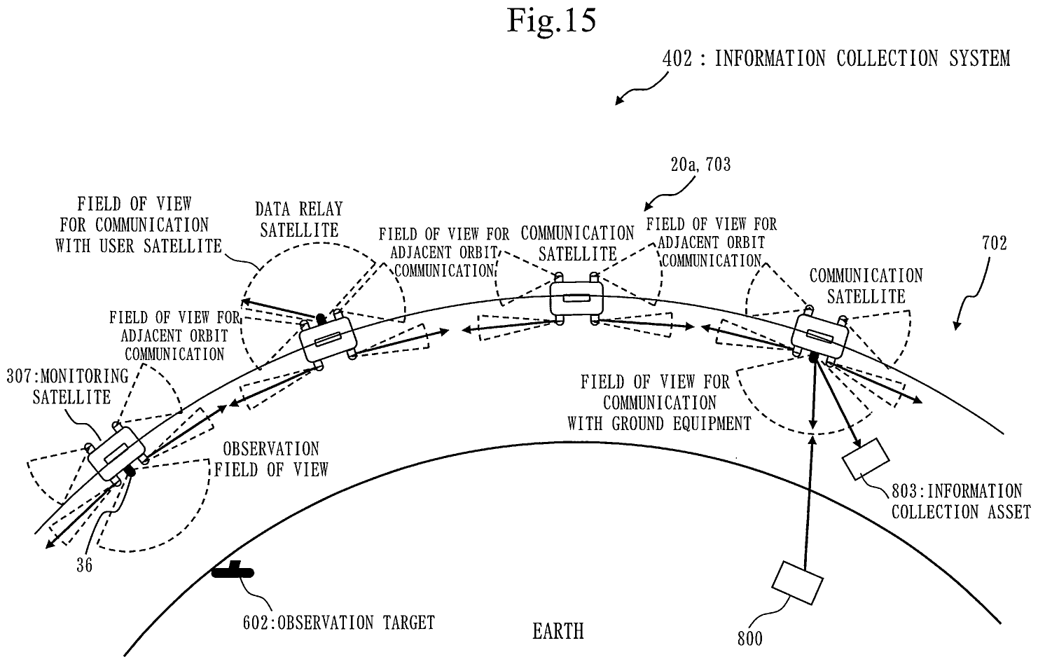

FIG. 15 is a diagram illustrating an information collection system 402 according to the present embodiment.

The monitoring satellite 307 that is an example of the satellite 30 includes the monitoring device 36. The monitoring device 36 is a light wave or radio wave information collection device. The monitoring device 36 acquires monitoring information such as image information of an observation target 602.

The information collection system 402 transmits monitoring information to the ground equipment 800 or information collection assets 803 on land, sea, and air via the mesh communication network 703 formed by the satellite constellation 20a described in Embodiment 2.

According to the information collection system 402, there is an advantageous effect that it is possible to detect image reconnaissance information obtained when a submarine, which is the observation target 602, surfaces at sea or radio wave information which is transmitted/received at the time of surfacing and immediately transmit monitoring information.

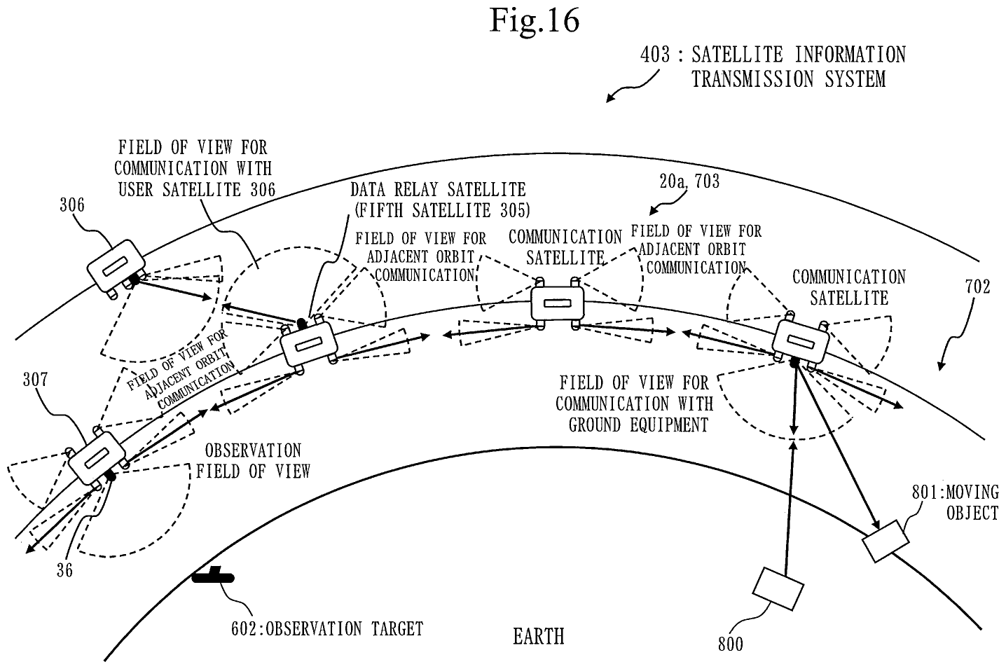

FIG. 16 is a diagram illustrating a satellite information transmission system 403 according to the present embodiment.

The satellite information transmission system 403 includes the fifth satellite 305 that communicates with the user satellite 306.

The satellite information transmission system 403 transmits/receives satellite information of the user satellite 306 to/from the ground equipment 800 or the moving object 801 on land, sea, or air via the mesh communication network 703 formed by the satellite constellation 20a described in Embodiment 2.

According to the satellite information transmission system 403, there is an advantageous effect that it is possible to immediately transmit satellite information of the user satellite 306 flying in an orbital plane or at an orbital altitude that is different from that of the satellite constellation 20a described in Embodiment 2.

### Embodiment 4

In the present embodiment, the points to be added to Embodiments 1 to 3 will be mainly described.

The present embodiment will provide the same reference characters to components having the same functions as those in Embodiments 1 to 3 and will omit the description thereof.

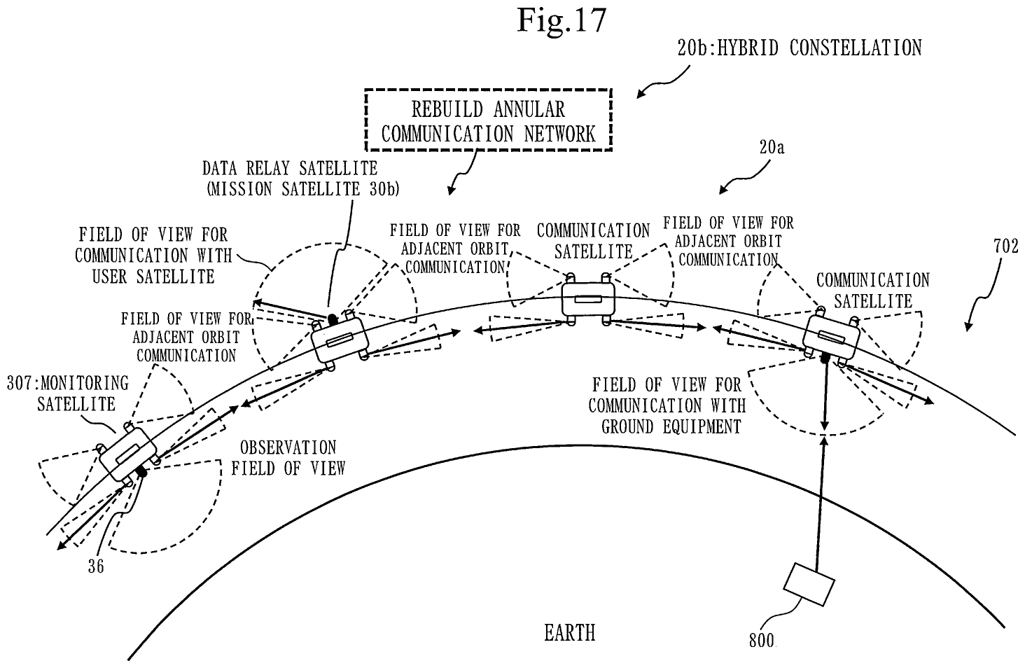

FIG. 17 is a diagram illustrating a configuration example of a hybrid constellation 20b according to the present embodiment.

The present embodiment will describe the hybrid constellation 20b and a hybrid constellation forming method for forming the hybrid constellation 20b.

The hybrid constellation 20b according to the present embodiment includes a communication constellation and a mission satellite. In the communication constellation, a plurality of satellites, which include communication devices communicating with satellites in front and behind in a traveling direction on the same orbital plane, form the annular communication network 702.

The communication constellation according to the present embodiment is similar to the satellite constellation 20 described in Embodiments 1 and 2.

The hybrid constellation 20b includes a mission satellite 30b that is provided with a communication device communicating with satellites in front and behind and a mission device executing various missions. The mission satellite 30b flies between satellites that form the communication constellation forming the annular communication network 702.

The hybrid constellation 20b is formed by rebuilding the annular communication network 702 with a plurality of satellites, which form the communication constellation forming the annular communication network 702, and the mission satellite 30b.

The hybrid constellation 20b is a hybrid constellation in which not only communication but also various missions are realized while various missions such as monitoring, observation, positioning, and collection of various types of information form a communication network. The hybrid constellation 20b may be read as a multi-mission platform.

Specifically, the mission satellite 30b includes the first communication device 501 which is described in Embodiment 1 and communicates with satellites in front and behind.

According to the hybrid constellation 20b, there is an advantageous effect that it is possible to transmit information of a mission device, which executes missions other than communication, via the annular communication network 702 in real time.

Various mission devices are mission devices, other than a communication device, such as a monitoring device, an observation device, a positioning device, or an information collection device. Further, various mission devices may be a data relay device or a communication device such as a communication device which communicates with various ground assets including moving objects.

For example, the mission satellite 30b may be an information acquisition satellite that is provided with a communication device, which communicates with satellites in front and behind, and an acquisition device for various types of satellite information. Here, the hybrid constellation 20b is also referred to as a satellite information transmission system.

Further, the mission satellite 30b may be an information collection satellite that is provided with an information collection device as a mission device. The information collection device collects information of a ground surface or a flying object launched from the ground surface. In this example, the hybrid constellation 20b transmits satellite information acquired by the information collection device across oceans or continents.

In addition, the mission satellite 30b may be a positioning signal transmission satellite that is provided with a positioning signal transmission device, which transmits positioning signals, as a mission device. In this example, the hybrid constellation 20b performs exchange of time control signals between satellites via the annular communication network 702 which is a rebuilt communication network.

### Embodiment 5

In the present embodiment, the points to be added to Embodiments 1 to 4 will be mainly described.

The present embodiment will provide the same reference characters to components having the same functions as those in Embodiments 1 to 4 and will omit the description thereof.

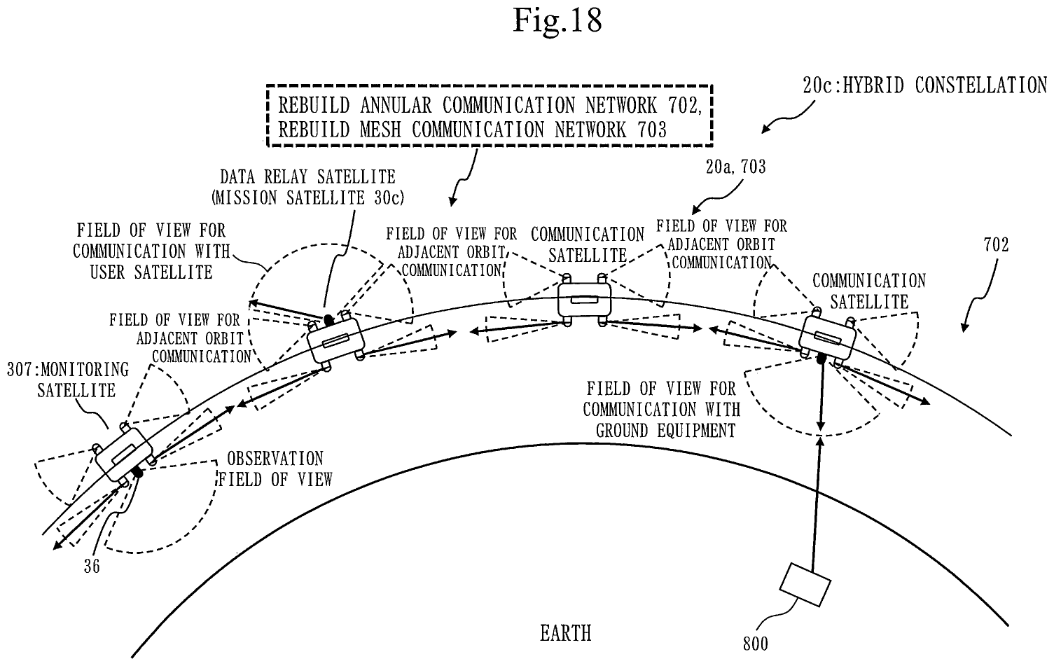

FIG. 18 is a diagram illustrating a configuration example of a hybrid constellation 20c according to the present embodiment.

The present embodiment will describe the hybrid constellation 20c and a hybrid constellation forming method for forming the hybrid constellation 20c.

The hybrid constellation 20c according to the present embodiment includes a communication constellation and a mission satellite. In the communication constellation, a plurality of satellites, which include communication devices communicating with satellites in front and behind in the traveling direction on the same orbital plane, form the annular communication network 702 and a plurality of satellites, which include communication devices communicating with left and right satellites on adjacent orbits, form the mesh communication network 703.

The communication constellation according to the present embodiment is similar to the satellite constellation 20a described in Embodiment 3.

The hybrid constellation 20c includes a mission satellite 30c that is provided with a communication device communicating with satellites in front and behind and a mission device executing various missions. The mission satellite 30c flies between satellites that form the communication constellation forming the annular communication network 702 and the mesh communication network 703.

The hybrid constellation 20c is formed by rebuilding the annular communication network 702 on the same orbital plane and by rebuilding the mesh communication network 703 with a communication constellation, which forms the annular communication network 702 and the mesh communication network 703, and the mission satellite 30c.

The hybrid constellation 20c is a hybrid constellation in which not only communication but also various missions are realized while various missions such as monitoring, observation, positioning, and collection of various types of information form a communication network. The hybrid constellation 20c may be read as a multi-mission platform.

For example, the mission satellite 30c may be an information acquisition satellite that is provided with a communication device, which communicates with satellites in front and behind, and an acquisition device for various types of satellite information. Here, the hybrid constellation 20c is also referred to as a satellite information transmission system.

Further, the mission satellite 30c may be an information collection satellite that is provided with an information collection device as a mission device. The information collection device collects information of a ground surface or a flying object launched from the ground surface. In this example, the hybrid constellation 20c transmits satellite information acquired by the information collection device across oceans or continents.

In addition, the mission satellite 30c may be a positioning signal transmission satellite that is provided with a positioning signal transmission device, which transmits positioning signals, as a mission device. In this example, the hybrid constellation 20c exchanges time control signals between satellites via the annular communication network 702 and the mesh communication network 703 which are rebuilt communication networks.

Specifically, the mission satellite 30c includes the first communication device 501 which is described in Embodiment 1 and communicates with satellites in front and behind.

The hybrid constellation 20c provides an advantageous effect that it is possible to comprehensively globally transmit information of various missions, in addition to the same advantageous effect as that of Embodiment 4.

### Embodiment 6

In the present embodiment, the points to be added to Embodiments 1 to 5 will be mainly described.

The present embodiment will provide the same reference characters to components having the same functions as those in Embodiments 1 to 5 and will omit the description thereof.

There is a concept to use a LEO (Low Earth Orbit) mega constellation as a positioning satellite. Satellite constellation time control technology without an atomic clock has been long awaited to achieve high-precision time control required for positioning satellites at low cost.

The present embodiment will describe examples of a hybrid constellation that contributes to realization of synchronous control and positioning missions. The hybrid constellation is the same as that described in Embodiments 4 and 5.

### Example 1 of Hybrid Constellation (Synchronous Control Signal)

This hybrid constellation includes a mission satellite which is provided with a high-precision master clock as a mission device, and exchanges synchronous control signals between a plurality of satellites.

There is an advantageous effect that even though individual satellites constituting the satellite constellation are not provided with high-precision clocks, high-precision time control can be realized by a synchronous control signal transmitted by a mission satellite (master clock satellite) provided with a high-precision master clock.

For example, when a mission device is a positioning mission, using a synchronous control signal transmitted by a master clock satellite provides an advantageous effect that makes it possible to deliver high-precision positioning signals from positioning satellites that are provided with no atomic clocks.

The positioning mission will be described below.

If a satellite that is provided with a high-precision clock such as an atomic clock and an optical lattice clock and a positioning signal transmission device as a mission device delivers a positioning signal in which precision orbital information of own satellite is contained, the satellite functions as a positioning satellite similarly to a GNSS such as a GPS and a quasi-zenith positioning satellite. GPS is an abbreviated word of Global Positioning System. GNSS is an abbreviated word of Global Navigation Satellite System.

However, since a high-precision clock to serve as a master clock is expensive, there is a problem in that a system in which all satellites are provided with a master clock is expensive.

Clocks such as a quartz clock standardly provided to satellites have inferior long-term stability to an atomic clock, having a problem in that a time error occurs when left unattended and operated for a long period of time.

If a satellite calibrates a standard clock with reference to a synchronous signal from a master clock while maintaining desired time accuracy, the satellite can function as a positioning satellite that maintains accurate time even without including a high-precision master clock.

### Example 2 of Hybrid Constellation (Synchronous Control Signal)

This hybrid constellation includes a mission satellite which is provided with a positioning signal receiver and a positioning signal transmitter as mission devices. In the hybrid constellation, accurate time is calculated based on a signal received by the positioning signal receiver so as to calibrate a clock of own satellite and synchronous control signals are exchanged between a plurality of satellites.

The positioning signal transmitter transmits a positioning signal that is a signal for satellite positioning,

The positioning signal receiver receives a positioning signal and calculates accurate time based on the received signal so as to calibrate the clock of own satellite.

A positioning signal receiver of a GNSS such as a GPS and a quasi-zenith satellite can calculate not only a position but also accurate time by receiving a positioning signal. Accordingly, even a satellite that is not provided with a master clock can calibrate and synchronize-control the clock of own satellite by using a GNSS as a master clock if the satellite is provided with a positioning signal receiver.

A standard clock which is calibrated by a master clock is hereinafter referred to as a slave clock. A method called GPS time synchronization is known as a synchronization method for a slave clocks.

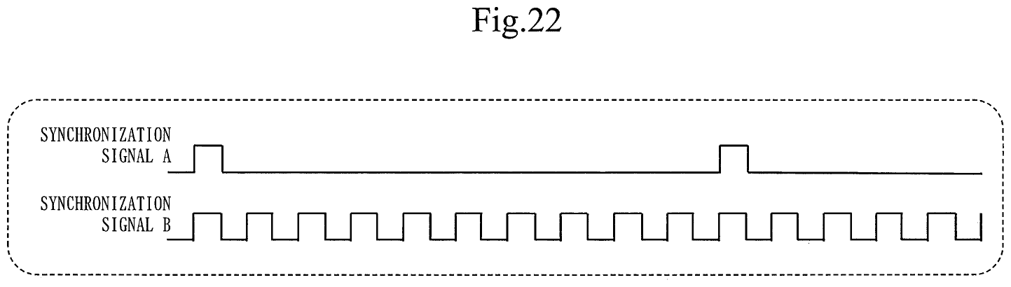

FIG. 22 is a diagram illustrating an example of a synchronous control method according to the present embodiment.

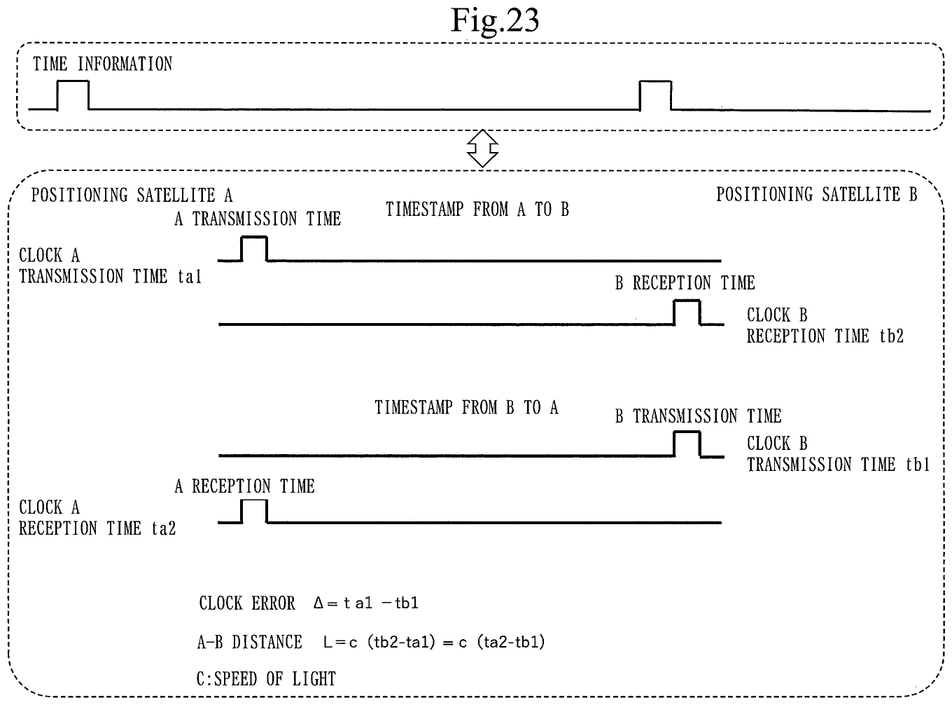

FIG. 23 is a diagram illustrating another example of the synchronous control method according to the present embodiment.

There is a method for simultaneously transmitting a synchronization signal A for coarse adjustment and a synchronization signal B for fine adjustment as synchronous control signals, as illustrated in FIG. 22.

Further, for example, a method for adding time information to a timing signal as illustrated in FIG. 23 is also effective.

For example, a positioning satellite A and a positioning satellite B that are provided with a bidirectional optical communication device as illustrated in FIG. 23 will be described.

Respective clocks provided to the positioning satellite A and the positioning satellite B add timestamp information of transmission time and reception time of synchronous control signals. If it is assumed that time difference between transmission time of A and reception time of B and time difference between transmitted time of B and reception time of A are originally accorded with each other when a relative distance L is constant, a relative error of the clocks provided to A and B can be derived.

Needless to say, even a radio wave communication device serving as a communication terminal can perform similar time control while taking into account a delay error, Doppler effect, or the like.

### Example 3 of Hybrid Constellation (Inter-Satellite Ranging)

This hybrid constellation includes satellites which are provided with a ranging device and the satellites measure distances between each other.

Increasing accuracy of orbital information, including positional information of the satellites that make up the hybrid constellation, helps to improve accuracy of a positioning service signal of a positioning mission.

In the hybrid constellation that synchronously flies in the same orbital plane with a controlled orbital period, there is an advantageous effect to be able to eliminate systematic errors and increase accuracy of orbital information by accurately measuring distances from satellites in front and behind and performing high-precision orbit determination processing of the orbital information on the ground.

As an inter-satellite ranging measure, for example, double-pass ranging may be performed in a manner such that a satellite provided with a laser ranging device receives a reflected laser from a laser reflector provided to a satellite flying in front. Alternatively, single-path ranging may be performed by transmitting and receiving optical communication terminal signals between time-synchronized satellites.

An optical communication terminal can be used as a ranging device.

Further, inter-satellite ranging between adjacent orbits provide an advantageous effect to be able to accurately measure satellite flying positions on difference orbital planes.

### Example 4 of Hybrid Constellation (Forward and Reverse Time Management)

In this hybrid constellation, satellites that form an annular communication network and fly in the same orbital plane perform forward time management for transmitting a time management signal in a satellite traveling direction and reverse time management for transmitting a time management signal in a reverse direction of the traveling direction.

Since a satellite moves in orbit at a higher speed than 4 km/second, the satellite is delayed relative to clocks on the ground in accordance with the special theory of relativity.

In addition, since the effect of gravity is weaker in orbit at an altitude of 20,000 km than on the earth's surface, the general theory of relativity makes clocks advance faster than clocks on the ground.

Combining the two effects, atomic clocks onboard GPS satellites advance 28.6 microseconds per day faster than clocks on the ground.

Since light travels approximately 11 km in 28.6 microseconds, only one day of this misalignment results in a GPS error of 11 km.

In a GNSS, atomic clock correction is made so as to counteract these relativistic effects.

Clock correction is also required to counteract the relativistic effects similarly when a positioning mission is realized by a hybrid constellation as well. Correction of slave clocks of satellites provided with no master clock requires elimination of systematic errors occurring in a synchronous control process. Time in forward time management and reverse time management and in-orbit information are compared and evaluated on the ground in a satellite group forming an annular communication network, providing an advantageous effect of being able to eliminate systematic errors.

### Example 5 of Hybrid Constellation (in-Orbit Generated Command Information)

In this hybrid constellation, command information for different mission devices which is generated in orbit is exchanged between a plurality of satellites.

Command information is automatically generated in orbit and exchanged between satellites, being able to rapidly perform coordinated operations of a plurality of satellites without time delays via the ground.

For example, in a flying object tracking system, a satellite which has detected launch automatically generates a positional coordinate of the launch point, on which the launch has been detected, in orbit and transmits monitoring instruction command information as a monitoring target positional coordinate to another monitoring satellite, being able to rapidly track the flying object.

### Example 6 of Hybrid Constellation (Flying Object Information Share)

In this hybrid constellation, flying object information acquired in orbit is exchanged between a plurality of satellites.

Flying object tracking systems have had a problem of time delay because flying object information obtained by an arbitrary monitoring satellite is transmitted by another monitoring satellite via ground equipment. According to the hybrid constellation of Example 6, flying object information can be directly transmitted to another monitoring satellite without being routed through ground equipment, providing an advantageous effect that flying object information can be shared without delay in flying object tracking which requires rapid response actions.

### Example 7 of Hybrid Constellation (Mission Satellite and Ground Equipment)

The hybrid constellation that is described in Embodiment 4 or 5 or any of Examples 1 to 6 of the present embodiment is constituted by including a front-rear communication device and a mission device. In this hybrid constellation, the mission satellite includes any of an optical information collection device, a radio wave information collection device, a laser generation device, a radio wave generation device, an infrared monitoring device, a positioning signal generation device, a radio wave data relay device, or an optical data relay device, as a mission device.

In addition, the ground equipment is a ground system that operates and controls the hybrid constellations of Examples 1 to 6 of the present embodiment.

### Embodiment 7

In the present embodiment, the points to be added to Embodiments 1 to 6 will be mainly described.

The present embodiment will provide the same reference characters to components having the same functions as those in Embodiments 1 to 6 and will omit the description thereof

The present embodiment will describe an example of a hybrid constellation that realizes more real-time and low-load data processing. The hybrid constellation is the same as that described in Embodiments 4, 5, and 6.

In the present embodiment, ground equipment is also referred to as a ground device, a ground system, or a ground data center. In addition, ground equipment is sometimes referred to merely as the ground.

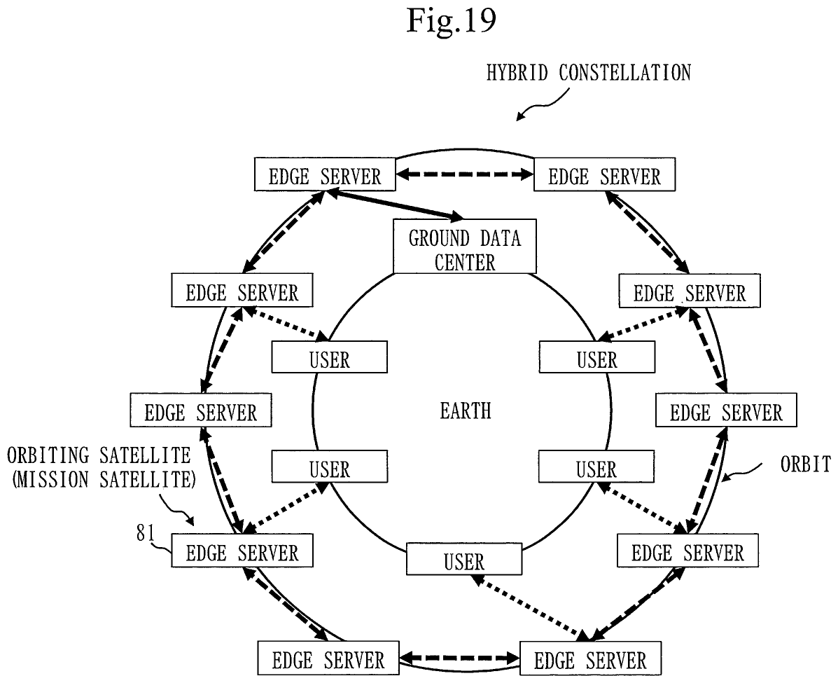

FIG. 19 is a diagram illustrating from Example 8 to Example 14 of a hybrid constellation according to the present embodiment.

FIG. 19 illustrates an example of a hybrid constellation including a mission satellite provided with an edge server 81.

### Example 8 of Hybrid Constellation (Edge Server)

In this hybrid constellation, a mission satellite is provided with an AI (artificial intelligence)-equipped calculator and an edge server and performs edge computing in orbit.

Edge computing, in which an edge server is provided on the IOT (Internet of Things) side, has been attracting attention as a method to realize a distributed architecture. In IoT, a centralized system is generally used in which data collected by sensors is transmitted to the cloud via the Internet and analyzed. On the other hand, the edge computing employs a system for performing distributed data processing by device bodies or edge servers located between the devices and the cloud. This realizes real-time and low-load data processing.

In addition, information amount increase occurring along with sophistication of the information society has caused a problem of increase in power consumption and raised an issue of heat exhaust countermeasures. Especially, centralized systems have serious issues of high power consumption and heat exhaust countermeasures for super computers or large-scale data centers.

On the other hand, heat can be exhausted to deep space by radiative cooling, in outer space. Therefore, it is rational that satellites are considered as devices in IOT and edge servers are provided to the satellite constellation side so as to perform distributed computing processing in orbit and then transmit only necessary data to the ground.

According to the hybrid constellation, there is an advantageous effect that information exchange is performed with the cloud in which a data center is provided to ground equipment via an annular communication network or a mesh communication network so as to be able to realize low delay (latency) and centralized data management.

The following purposes are the purposes of distributed computing processing.
Purpose for reducing a load on ground processing by performing in-orbit distributed computing processing with respect to what has been conventionally processed by cloud computing on the ground
Purpose for reducing an amount of data which is transmitted to the ground, by performing in-orbit distributed computing processing with respect to satellite information acquired by a mission satellite
Purpose for performing autonomous in-orbit system management such as collision prevention within own system of satellite constellation
Purpose for accelerating decision making in emergency situations in a manner such that in-orbit acquired information is rapidly processed and distributed computing of information, which is to be reflected to an in-orbit next process, is performed by autonomous decision so as to eliminate information exchange with the ground system

The following advantageous effects are the advantageous effects obtained when a satellite considered as an IOT device in orbit performs distributed computing.
Solving the exhaust heat problem caused by power increase and concentration in ground equipment
Reduction in ground processing load by reducing the data amount of satellite information which is to be transmitted to the ground
Reduction in ground processing load by autonomous system management of satellite constellation
Faster response in emergency situations

Further, there is an advantageous effect of reducing greenhouse gas emissions and contributing to SDGs (Sustainable Development Goals) on the ground, as an advantageous effect of reducing ground processing load.

### Example 9 of Hybrid Constellation (Edge Server, Collision Avoidance)

In the hybrid constellation of Example 8, edge servers store orbital information of a satellite group constituting the constellation. In addition, a calculator equipped with AI analyzes a collision risk between the satellites constituting the constellation.

In a satellite constellation in which satellites fly at the same altitude on a plurality of orbital planes whose normal vectors are mutually different, there is a risk that collision occurs on intersections of the orbital planes.

Accordingly, constituent satellites of a hybrid constellation include edge servers, and the edge servers store orbital information of the group of satellites constituting the constellation and perform risk analysis. If there is a satellite whose collision is predicted in advance, the edge server imparts a command for operating a propulsion device in orbit. This makes it possible to avoid collision and ensure flight safety in the hybrid constellation.

### Example 10 of Hybrid Constellation (Flying Object Information Transmission)

In the hybrid constellation of Example 8, edge servers store orbital information of a satellite group constituting the constellation and flying object information acquired by a satellite constituting the constellation. Then, a calculator equipped with AI transmits the flying object information to satellites constituting the constellation.

A monitoring satellite which serves as a mission satellite and is provided with a monitoring device acquires launch detection information of a flying object and transmits the information to satellites provided with the edge servers. Then, calculators of the satellites provided with the edge servers select monitoring satellites which are capable of tracking and monitoring a flying object to transmit the flying object information, thus realizing flying object tracking.

### Example 11 of Hybrid Constellation (Flight Path Prediction)

In the hybrid constellation of Example 8 or Example 10, a calculator equipped with AI analyzes a flight path based on flying object information acquired from a plurality of monitoring satellites and foresight information stored in edge servers. Then, the calculator equipped with AI transmits the flying object information to a monitoring satellite which is able to track the predicted flight path.

The edge server stores a type of a flying object, a type of propellant, a flyable distance, and a typical flight profile as a flying object model serving as foresight information. The edge server acquires flying object tracking information, which is acquired by a monitoring satellite provided with a monitoring device as a mission satellite, from a plurality of monitoring satellites. The calculator equipped with AI refers to the flying object model so as to predict and analyze a flight path based on AI machine learning inference. Then, the calculator equipped with AI transmits the flying object information to a monitoring satellite which is able to track the predicted flight path, thus realizing flying object tracking.

### Example 12 of Hybrid Constellation (Landing Prediction)

In the hybrid constellation of Example 8, Example 10, or Example 11, a calculator equipped with AI performs flying object landing prediction based on flying object information acquired from a plurality of monitoring satellites and foresight information stored in edge servers. Then, the calculator equipped with AI selects a satellite which can transmit the flying object information to a ground asset, which enables handling, so as to transmit a flying object information transmission command.

The edge server stores positional information of deployment of flying object handling assets, as foresight information. Further, the calculator equipped with AI predicts a landing position through AI machine learning and transmits flying object information to a handling asset which is positioned in the vicinity of the predicted landing position, enabling flying object handling.

### Example 13 of Hybrid Constellation (Synthetic Aperture Processing)

In the hybrid constellation of Example 8, a mission satellite is provided with a synthetic aperture radar. In a mission satellite, acquired information is stored in an edge server. Further, a calculator generates an image by synthetic aperture processing in orbit and transmits image data to the ground.

In terms of an observation satellite provided with a synthetic aperture radar, synthetic aperture processing and imaging processing have been carried out on the ground. However, the amount of data transmitted from the observation satellite to the ground is enormous and therefore, a system that performs synthetic aperture processing in orbit and transmits only image data to the ground has been long awaited. Performing in-orbit edge computing provides an advantageous effect that the amount of data transmitted to the ground can be reduced and a load on the ground processing can be reduced.

Here, a plurality of mission satellites may be provided with a synthetic aperture radar and the plurality of mission satellites may store monitoring information acquired from the same observation target to an edge server and perform synthetic aperture processing.

Needless to say, processing can be performed via a communication network even when a satellite provided with a synthetic aperture radar, a satellite carrying a calculator, and a satellite carrying an edge server are separate from each other.

### Example 14 of Hybrid Constellation (Super-Resolution Processing)

In the hybrid constellation of Example 8, a mission satellite is provided with an optical monitoring device. In a mission satellite, acquired information is stored in an edge server. Further, a calculator generates an image by super-resolution processing in orbit and transmits image data to the ground.

In super-resolution processing of an image that is acquired by an observation satellite provided with an optical monitoring device, super-resolution processing has been performed at ground processing equipment after transmitting image information to the ground. However, the amount of data transmitted from the observation satellite to the ground is enormous and therefore, a system that performs super-resolution processing in orbit and transmits only image data to the ground has been long awaited. Performing in-orbit edge computing provides an advantageous effect that the amount of data transmitted to the ground can be reduced and a load on the ground processing can be reduced.

Here, a plurality of mission satellites may be provided with an optical monitoring device and the plurality of mission satellites may store monitoring information acquired from the same observation target to an edge server and perform super-resolution processing.

Needless to say, processing can be performed via a communication network even when a satellite provided with an optical monitoring device, a satellite carrying a calculator, and a satellite carrying an edge server are separate from each other.

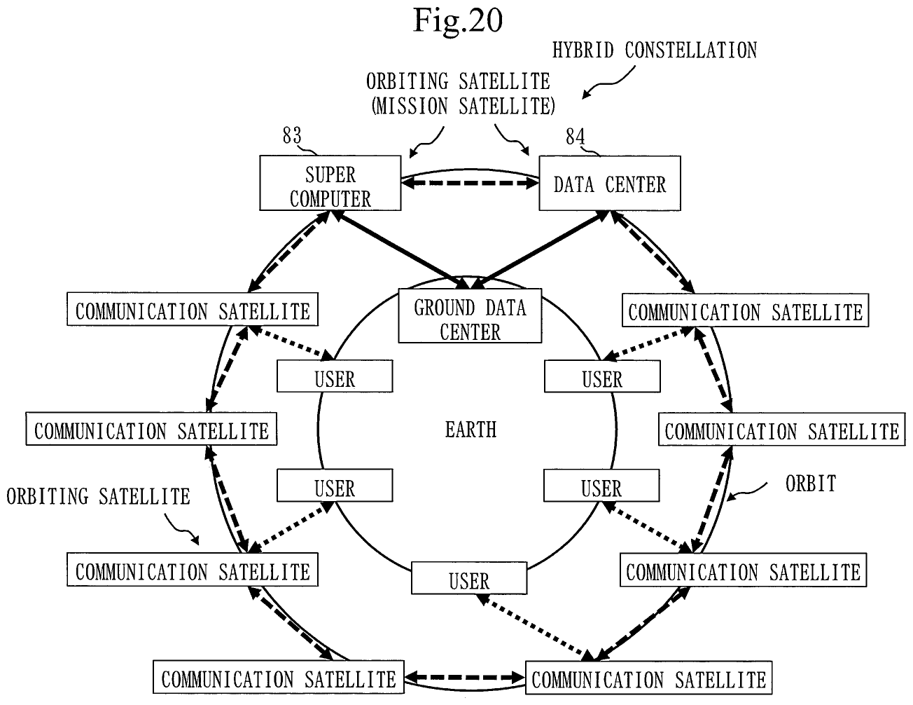

FIG. 20 is a diagram illustrating Example 15 of the hybrid constellation according to the present embodiment.

FIG. 20 illustrates an example of a hybrid constellation including a mission satellite that is provided with both or either one of a super computer 83 and a data center 84.

### Example 15 of Hybrid Constellation

In this hybrid constellation, a mission satellite is provided with both or either one of a super computer and a data center.

Information amount increase occurring along with sophistication of the information society has caused a problem of increase in power consumption and raised an issue of heat exhaust countermeasures. Especially, centralized systems have serious issues of high power consumption and heat exhaust countermeasures for super computers or large-scale data centers.

On the other hand, heat can be exhausted to deep space by radiative cooling, in outer space. A super computer or a data center for realizing a cloud environment can be provided on the satellite constellation side. A mission satellite performs arithmetic processing in orbit and then transmits only necessary data to users on the ground, being able to maintain a cloud environment and reduce greenhouse gas emissions. This provides an advantageous effect of contributing to SDGs on the ground.

Further, according to the hybrid constellation, information exchange can be performed with an arbitrary user on the ground via an annular communication network or a mesh communication network. This provides an advantageous effect that data of each satellite constituting a hybrid constellation and distributed computing considered as IOT can be centrally managed with low delay (latency).

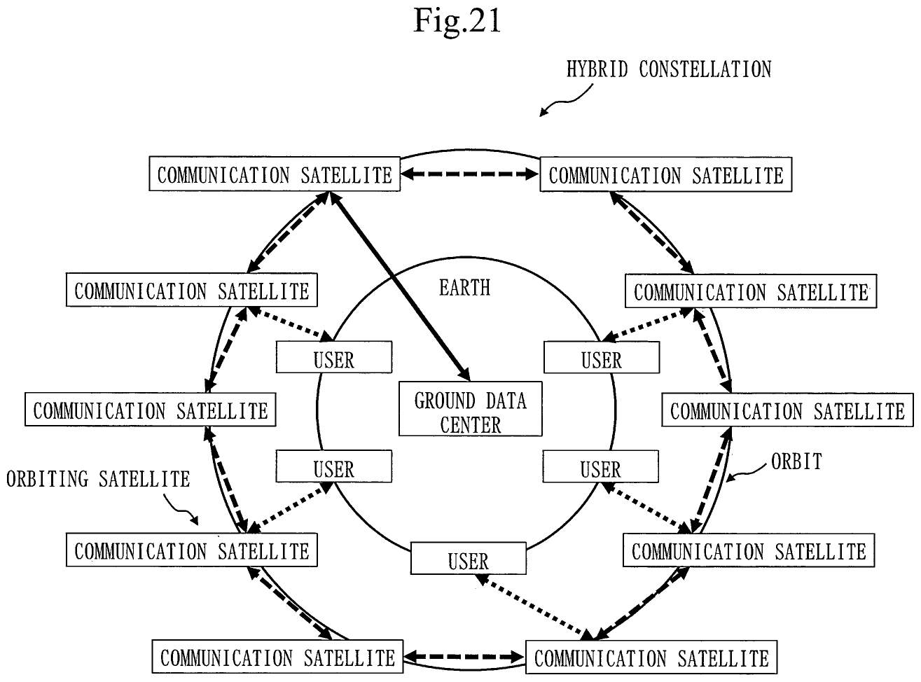

FIG. 21 is a diagram illustrating Example 16 of ground equipment communicating with the hybrid constellation according to the present embodiment.

FIG. 21 illustrates an example of ground equipment provided with both or either one of a super computer and a data center.

### Example 16 of Ground Equipment Communicating with Hybrid Constellation

Ground equipment is also called a ground data center.

Ground equipment is provided with a super computer or a data center and is located in a high latitude region with a latitude of 50 degrees or greater. The ground equipment exchanges information via a hybrid constellation.

A calculator constituting a super computer or a large-scale data center consumes a lot of power and generates a lot of heat. Therefore, operation has been performed in ground equipment provided with a large-scale cooling facility. However, there has been a problem in that high power consumption or exhaust heat to the outside is a disadvantage from the viewpoint of SDGs.

With the spread of cloud computing, locations of super computers or data centers are no longer a constraint for users. If high-speed communication lines are secured, it is reasonable to deploy equipment, which consumes a large amount of power and generates a lot of heat, in a colder high-latitude region.

On the other hand, in laying an optical fiber communication network and the like on the ground, there has been a problem in that a significant cost disadvantage arises to lay large-capacity communication networks from high latitude regions to metropolitan areas where users are concentrated.

In contrast, according to a hybrid constellation that is formed at an orbital altitude of approximately 350 km, for example, and in which an annular or mesh communication network is formed by optical communication terminals, it is easy to secure an information communication network from high latitude regions to metropolitan areas. Thus, there is an advantageous effect that a low delay (latency) can be realized.

In addition, since polar-orbiting satellites pass over a polar region every orbit, there is an advantageous effect that communication capacity can be easily expanded for high latitude regions including polar regions.

Even for inclined orbit satellites, a satellite flying northward from the southern hemisphere flies from west to east at the northernmost point of the orbital plane and changes its traveling direction from the northern hemisphere to the southward direction. A satellite flying southward from the northern hemisphere flies from west to east at the southernmost point of the orbital plane and changes its traveling direction from the southern hemisphere to the northward direction. Accordingly, there is an advantageous effect that it is easy to expand communication capacity between a satellite and ground equipment which is located in high latitude regions including the polar regions at the northernmost and southernmost points on the orbital plane in a region where a satellite flies from west to east, in an orbit whose orbital inclination angle is 50 degrees or greater.

Further, by limiting communication lines with data centers located in high latitude regions, including the polar regions, to communications with satellites with robust security measures, an advantageous effect that it is possible to build a data center with a robust security environment that is shielded from cyberattacks is obtained.

A plurality of parts in above-described Embodiments 1 to 7 may be combined and carried out. Alternatively, one part in these embodiments may be carried out. In addition, these embodiments may be carried out in any combination as a whole or partially.

That is, in Embodiments 1 to 7, any parts of Embodiments 1 to 7 can be freely combined, components can be arbitrarily transformed, or components in Embodiments 1 to 7 can be arbitrarily omitted.

It should be noted that the embodiments described above are essentially preferred examples and are not intended to limit the scope of the present disclosure, the scope of the application of the present disclosure, and the scope of the uses of the present disclosure. The above-described embodiments can be variously modified as needed.

### REFERENCE SIGNS LIST

11, 11b: satellite constellation forming unit; 20, 20a, 201, 202, 203, 204: satellite constellation; 20b, 20c: hybrid constellation; 21: orbital plane; 30: satellite; 30b, 30c: mission satellite; 31: satellite control device; 32: communication device; 33: propulsion device; 34: attitude control device; 35: power supply device; 36: monitoring device; 55: orbit control command; 71, 72: communication link; 301: first satellite; 302: second satellite; 303: third satellite; 304: fourth satellite; 305: fifth satellite; 306: user satellite; 307: monitoring satellite; 401: flying object handling system; 402: information collection system; 403: satellite information transmission system; 501: first communication device; 502: second communication device; 503: third communication device; 504: fourth communication device; 510: orbit control command generation unit; 520: analysis prediction unit; 601: flying object; 602: observation target; 600: satellite constellation forming system; 700, 800: ground equipment; 702: annular communication network; 703: mesh communication network; 801: moving object; 802: flying object handling asset; 803: information collection asset; 910: processor; 921: memory; 922: auxiliary storage device; 930: input interface; 940: output interface; 941: display device; 950: communication device; 81: edge server; 83: super computer; 84: data center

1.-9. (canceled)

10. A hybrid constellation formed in a LEO (Low Earth Orbit) comprising:
a communication constellation in which a plurality of satellites, the plurality of satellites including a communication device that communicates with satellites in front and behind in a traveling direction on a same orbital plane, form an annular communication network; and
a mission satellite to be provided with a communication device to communicate with satellites in front and behind and a mission device to execute a mission, wherein
the mission satellite flies between a plurality of satellites forming the communication constellation, and
the hybrid constellation is formed by rebuilding the annular communication network with a use of the mission satellite and the plurality of satellites forming the communication constellation.

11. A hybrid constellation formed in a LEO (Low Earth Orbit) comprising:
a communication constellation in which a plurality of satellites, the plurality of satellites including a communication device that communicates with satellites in front and behind in a traveling direction on a same orbital plane, form an annular communication network, and a plurality of satellites, the plurality of satellites including a communication device that communicates with left and right satellites on adjacent orbits, form a mesh communication network; and
a mission satellite to be provided with a communication device to communicate with satellites in front and behind and a mission device to execute a mission, wherein
the mission satellite flies between a plurality of satellites forming the communication constellation, and
the hybrid constellation is formed by rebuilding the annular communication network and rebuilding the mesh communication network with a use of the mission satellite and the plurality of satellites forming the communication constellation.

12. A hybrid constellation forming method comprising:
forming a hybrid constellation formed in a LEO (Low Earth Orbit) including
a communication constellation in which a plurality of satellites, the plurality of satellites including a communication device that communicates with satellites in front and behind in a traveling direction on a same orbital plane, form an annular communication network, and
a mission satellite to be provided with a communication device to communicate with satellites in front and behind and a mission device to execute a mission, wherein
the mission satellite flies between a plurality of satellites forming the communication constellation, and
the annular communication network is rebuilt with a use of the mission satellite and the plurality of satellites forming the communication constellation so as to form the hybrid constellation.

13. A hybrid constellation forming method comprising:
forming a hybrid constellation formed in a LEO (Low Earth Orbit) including
a communication constellation in which a plurality of satellites, the plurality of satellites including a communication device that communicates with satellites in front and behind in a traveling direction on a same orbital plane, form an annular communication network, and a plurality of satellites, the plurality of satellites including a communication device that communicates with left and right satellites on adjacent orbits, form a mesh communication network, and
a mission satellite to be provided with a communication device to communicate with satellites in front and behind and a mission device to execute a mission, wherein
the mission satellite flies between a plurality of satellites forming the communication constellation, and
the annular communication network is rebuilt and the mesh communication network is rebuilt with a use of the mission satellite and the plurality of satellites forming the communication constellation so as to form the hybrid constellation.

14.-15. (canceled)

16. The hybrid constellation according to claim 10, wherein
the mission satellite is an information collection satellite that is provided with an information collection device as the mission device, the information collection device collecting information of a ground surface or a flying object launched from the ground surface, and
satellite information acquired by the information collection device is transmitted across an ocean or a continent.

17. The hybrid constellation according to claim 10, wherein
the mission satellite is a positioning signal transmission satellite that is provided with a positioning signal transmission device as the mission device, the positioning signal transmission device transmitting a positioning signal, and
exchange of a time control signal between satellites is performed via a rebuilt communication network.

18. A ground system to operate and control the hybrid constellation according to claim 10.

19. The hybrid constellation according to claim 10, wherein
a mission satellite provided with a high-precision master clock as the mission device is included, and a synchronous control signal is exchanged between a plurality of satellites.

20. The hybrid constellation according to claim 10, wherein
a mission satellite provided with a positioning signal receiver and a positioning signal transmitter as the mission device is included, and
accurate time is calculated based on a signal received by the positioning signal receiver so as to calibrate a clock of own satellite and a synchronous control signal is exchanged between a plurality of satellites.

21. The hybrid constellation according to claim 10, wherein
satellites provided with a ranging device are included and the satellites measure a distance between each other.

22. The hybrid constellation according to claim 10, wherein
satellites that form an annular communication network and fly in a same orbital plane perform forward time management for transmitting a time management signal in a satellite traveling direction and reverse time management for transmitting a time management signal in a reverse direction of the satellite traveling direction.

23. The hybrid constellation according to claim 10, wherein
command information for the mission devices that are different from each other, the command information being generated in orbit, is exchanged between a plurality of satellites.

24. The hybrid constellation according to claim 10, wherein
flying object information acquired in orbit is exchanged between a plurality of satellites.

25. A mission satellite that is provided with a front-rear communication device and a mission device and constitutes the hybrid constellation according to claim 10, wherein
any of an optical information collection device, a radio wave information collection device, a laser generation device, a radio wave generation device, an infrared monitoring device, a positioning signal generation device, a radio wave data relay device, and an optical data relay device is included as the mission device.

26. A ground system to operate and control the hybrid constellation according to claim 19.

27. The hybrid constellation according to claim 10, wherein
a calculator equipped with AI (artificial intelligence) and an edge server are provided as the mission satellite and edge computing is performed in orbit.

28. The hybrid constellation according to claim 27, wherein
the edge server stores orbital information of a satellite group constituting a constellation, and the calculator equipped with AI analyzes a collision risk between satellites constituting the constellation.

29. The hybrid constellation according to claim 27, wherein
the edge server stores orbital information of a satellite group constituting a constellation and flying object information acquired by a satellite constituting the constellation, and the calculator equipped with AI transmits the flying object information to a satellite constituting the constellation.

30. The hybrid constellation according to claim 27, wherein
the calculator equipped with AI analyzes a flight path based on flying object information acquired from a plurality of monitoring satellites and foresight information stored in the edge server and transmits the flying object information to a monitoring satellite that can track a predicted flight path.

31. The hybrid constellation according to claim 27, wherein
the calculator equipped with AI performs flying object landing prediction based on flying object information acquired from a plurality of monitoring satellites and foresight information stored in the edge server and selects a satellite that can transmit the flying object information to a ground asset, the ground asset enabling handling, so as to transmit a flying object information transmission command.

32. The hybrid constellation according to claim 27, wherein
the mission satellite is provided with a synthetic aperture radar and stores acquired information in the edge server, and
the calculator generates an image by synthetic aperture processing in orbit and transmits image data to a ground.

33. The hybrid constellation according to claim 27, wherein
the mission satellite is provided with an optical monitoring device and stores acquired information in the edge server, and
the calculator generates an image by super-resolution processing in orbit and transmits image data to a ground.

34. The hybrid constellation according to claim 10, wherein
both or either one of a super computer and a data center are or is provided as the mission satellite.

35. Ground equipment that is provided with a super computer or a data center and is located in a high latitude region with a latitude of 50 degrees or greater, wherein
information is exchanged via the hybrid constellation according to claim 10.
